(19) United States
(12) Patent Application Publication
(10) Pub. No.: US 2008/0182751 A1
(43) Pub. Date: Jul. 31, 2008

(54) Brassicaceae Plant Materials and Method for Their Use as Biopesticides

(75) Inventors: Matthew J. Morra, Moscow, ID (US); Vladimir Borek, Moscow, ID (US); Jack Brown, Moscow, ID (US); Donn Thill, Moscow, ID (US)

Correspondence Address: KLARQUIST SPARKMAN, LLP, 121 SW SALMON STREET, SUITE 1600, PORTLAND, OR, 97204, US

(73) Assignee: Idaho Research Foundation, Inc.

(21) Appl. No.: 11/770,569

(22) Filed: Jun. 28, 2007

Related U.S. Application Data
(60) Provisional application No. 60/818,135, filed on Jun. 30, 2006.

(51) Int. Cl. A01N 63/00; A01N 65/00; A01P 5/00; A01P 3/00; A01P 7/04; A01P 13/00

(52) U.S. Cl. 504/117; 424/755; 424/725; 504/189; 504/118; 424/93.1; 424/754

(57) ABSTRACT

Disclosed embodiments concern a process for controlling plant pests, such as insects, nematodes, fungi, weeds, and combinations thereof, with specific embodiments being particularly useful for weed suppression. One disclosed embodiment comprises providing a plant, or a portion thereof, selected from the family Brassicaceae, particularly from the genera Brassica and Sinapis, and even more particularly from the genus Sinapis. Plant material is applied to soil prior to crop planting, simultaneously with crop planting, or subsequent to emergence of desired plants. The method may further comprise processing plant material. For example, with reference to Sinapis alba processing can include crushing the plants to obtain seed meal, which can be applied as obtained, or can be in other useful forms, such as pellets. Alternatively, effective glucosinolates may be extracted from plant material, either with or without first pressing the plant material. Extracted glucosinolates are applied to soil, followed by applying myrosinase, or alternatively the glucosinolate and myrosinase can be co-applied, to soil. Plant material or processed plant material may be combined with at least one additional material to form a composition, such as natural pesticides, natural fertilizers, synthetic fertilizers, synthetic herbicides, synthetic pesticide, surfactants, binders, colorants, pH adjusters/stabilizer, capsaicin, onion tissue, one or more microorganism, one or more products provided by a microorganism, or combinations thereof. The method also can include controlling the amount of water and/or pH added to soil, and or pH, to which the plant material, processed plant material, composition comprising plant material, or composition comprising processed plant material, is applied. The water and/or pH is selected to maintain bioactivity.

### CROSS-REFERENCE TO RELATED APPLICATION

This application claims the benefit the earlier filing date of U.S. Provisional Application No. 60/818,135 filed on Jun. 30, 2006. The entire disclosure of the provisional application is considered to be part of the disclosure of the present application and is hereby incorporated by reference.

### ACKNOWLEDGMENT OF GOVERNMENT SUPPORT

The present technology was developed, at least in part, using funds provided by the Department of Energy under DOE-NREL Contract XC092909501, and funds from the USDA under Grant No. USDA-CSREES2005-35101-15348. The Federal Government may have rights in this invention.

### FIELD

Disclosed embodiments of the present invention concern using plant material, or compositions derived therefrom, from the family Brassicaceae as biopesticides.

### BACKGROUND

Currently, there is a strong desire by consumers to use products that are produced without using synthetic pesticides. Many commonly used pesticides are no longer used, or their use soon will be discontinued. For example, the use of methyl bromide is being restricted. This desire for consumers to have substantially synthetic pesticide-free materials must be balanced by the practicalities required for feeding an ever-increasing world-wide population. Thus, some method of controlling weeds and/or insects must be implemented.

Farmers throughout the world are constantly looking for ways to improve soil quality, reduce inputs, and enhance yield and produce quality. The use of plant materials to suppress soil-borne pests and plant pathogens has been referred to as “biofumigation” and the species used as “biofumigants.” Pest and disease suppression are not the only advantages of using biofumigants. Species such as oilseed radish have shown high potential to increase soil aeration and to scavenge residual nitrogen. Several research studies have recently been published and many are currently ongoing throughout the nation and the world to better understand and quantify the contributions of biofumigants to cropping systems.

Plants may produce compounds that directly or indirectly affect their biological environment. These compounds fall within a broad category of compounds called allelochemicals, and are exclusive of food that influences growth, health, or behavior of other organisms. One reason for interest in allelochemicals is their potential for use in alternative pest management systems. Using plant-produced allelochemicals in agricultural and horticultural practices could minimize synthetic pesticide use, reduce the associated potential for environmental contamination, and contribute to a more sustainable agricultural system.

### SUMMARY

One embodiment of the present invention concerns a process for controlling plant pests and/or suppressing weeds in plant crops. For example, the method may be practiced to control insects, nematodes, fungi, weeds, and combinations thereof, with specific embodiments being particularly useful for weed suppression. One disclosed embodiment comprises providing plant material selected from the family Brassicaceae, particularly from the genera Brassica and Sinapis, and more particularly from the genus Sinapis. Plant material or a composition comprising plant material is applied to soil prior to crop planting, simultaneously with crop planting, or subsequent to emergence of desired plants.

The method may further comprise processing plant material to produce a processed plant material, or a composition comprising processed plant material. For example, with reference to Sinapis alba to exemplify the invention, processing can include crushing the plants to obtain seed meal, which is applied to soil. The seed meal can be applied as obtained, or can be in other useful forms, such as pellets. Moreover, effective glucosinolates may be extracted from plant material, either with or without first pressing the plant material. Extracted glucosinolates then can be applied to soil, followed by applying myrosinase, or alternatively the glucosinolate and myrosinase can be co-applied, to the soil in amounts effective to produce biopesticides in amounts effective to control plant pests.

Plants other than the particular species disclosed herein to exemplify the invention also may be useful. Such plants can be selected based, at least in part, on those that produce one or more glucosinolates that result in production of bioactive agents, such as isothiocyanates and ionic thiocyanates, particularly ionic thiocyanates. One example of such a glucosinolate is 4-hydroxybenzyl glucosinolate. Thus, the concentration of 4-hydroxybenzyl glucosinolate in dry plant material can be determined, typically substantially oil-free plant material (plant material having from substantially 0% to about 15% residual oil, more typically 7-12%, and even more typically 10-12% residual oil). Effective amounts of 4-hydroxybenzyl glucosinolate typically range from about 10 μmol/gram to about 500 μmol/gram, more typically from about 50 μmol/gram to about 250 μmol/gram.

A person of ordinary skill in the art will appreciate that the plant material or processed plant material may be combined with at least one additional material to form a composition. By way of example, and without limitation, the additional material may be selected from natural pesticides, natural fertilizers, synthetic fertilizers, synthetic herbicides, synthetic pesticide, binders, colorants, pH adjusters/stabilizer, surfactants, capsaicin, onion tissue, one or more microorganism, one or more products provided by a microorganism, or combinations thereof.

The method also can include controlling the amount of water and/or pH added to soil to which the plant material, processed plant material, composition comprising plant material or composition comprising processed plant material is applied. The water and/or pH is selected to maintain bioactivity. With reference to watering, the water amount typically is from about 0.0625 ( 1/16) inch of water up to about 0.75, more typically from about 0.125 (⅛) inch to up to about 0.5 inch of water.

With reference to pH, the pH levels are advantageously maintained at a pH level selected to provide a desired bioactive agent. For example, if isothiocyanate is the desired active agent then lower pH values of less than about 5.0 will promote its stability. Alternatively, if ionic thiocyanate is the desired active agent, then the pH can be from at least as high as pH 7 (where the half life of the isothiocyanate precursor is only 4.8 minutes).

The method also can include top dressing or amending the meal to the soil surface. Alternatively, the method can comprise incorporating plant material, processed plant material, composition comprising plant material or composition comprising processed plant material, into the top several, e.g., 2 inches of soil. Generally, plant material, processed plant material, composition comprising plant material or composition comprising processed plant material, is applied to soil prior to planting desired crops. But, for certain crops, the plant material, processed plant material, composition comprising plant material, or composition comprising processed plant material is applied at the same time food crops are planted. For example, for the exemplary Sinapis alba, such plant material may be used even with plant emergents where the food crop is carrots, celery, spinach or combinations thereof. Sinapis alba has been found to be particularly effective for suppressing weeds selected from the group consisting of prickly lettuce (Lactuca serriola), mayweed chamomile (Anthemis cotula), common lambsquarters (Chenopodium album), wild oat (Avena fatua), redroot pigweed (Amaranthus retroflexus), and combinations thereof.

Another disclosed embodiment concerns the addition of water to plant material and/or seed meal to effectively produce bioactive agents, such as ionic thiocyanate. The extract, comprising an aqueous composition of bioactive agents, such as the ionic thiocyanate, can then be applied to the soil by spraying. An alternative embodiment involves combining the extract with surfactants or other adjuvants in order to increase the efficacy of the process.

The foregoing and other objects, features, and advantages of the invention will become more apparent from the following detailed description, which proceeds with reference to the accompanying figures.

### BRIEF DESCRIPTION OF THE DRAWINGS

FIG. 1 is a graph of glucosinolate concentrations (μmol glucosinolates per gram seed meal determined without using a response factor) for various plant materials as determined using hot water and methanol extractions. Athena and Dwarf Essex are B. napus species, Ida is a S. alba species, and Pac Gold is a B. juncea species. Ida samples m4 and m5 represent two different S. alba meal samples.

FIG. 2 is a graph of glucosinolate concentrations (μmol glucosinolates per gram seed meal determined without using a response factor) for various plant materials to compare total glucosinolates in stored or freshly pressed meals. Athena and Dwarf Essex are B. napus species, Idagold is a S. alba species, and Pac Gold is a B. juncea species.

FIG. 3 is an image illustrating the effects of Sinapis alba for weed control as compared to a no-meal control in a greenhouse trial conducted with soil. The weeds include wild oat and redroot pigweed.

FIG. 4 is a plot of colony diameter versus time (days) showing inhibition of F. oxysporum mycelial growth by volatile products from B. juncea Pacific Gold meal. Bj=B. juncea Pacific Gold; Bn DEx=B. napus Dwarf Essex; Bn A=B. napus Athena; Sa=S. alba Idagold; C=Control without meal.

FIG. 5 is a plot of seed or seedling mortality versus percent S. alba meal amendment for two common weeds grown in a silt loam soil. Meal amendment is expressed on a weight basis for the ratio of the meal to the soil.

FIG. 6 is a plot showing continuous and periodic extraction into ethyl acetate of 4-hydroxybenzyl isothiocyanate resulting from hydrolysis of 4-OH benzyl glucosinolate contained in S. alba seed meal as compared to similar extractions of benzyl isothiocyanate from aqueous solution. 4-Hydroxybenzyl isothiocyanate incubations contained no seed meal, but are expressed on a weight basis for comparison purposes only.

FIG. 7 provides first-order plots for the disappearance of 4-hydroxybenzyl isothiocyanate incubated in buffered aqueous solutions with pH values ranging from 3.0 to 6.5, where plots for pH 3.0 and 3.5 are superimposed on each other in the graph.

FIG. 8 illustrates the production of ionic thiocyanate from S. alba seed meal incubated in deionized water and aqueous solutions buffered at pH values ranging from 4.0 to 7.0.

FIG. 9 is a graph of isothiocyanate (ITC) formation from B. juncea Pacific Gold meal product versus time (hours).

FIG. 10 is a graph of isothiocyanate (ITC) formation from S. alba IdaGold meal product versus time (hours).

FIG. 11 is a graph of isothiocyanate (ITC) formation from B. napus Dwarf Essex meal product versus time (hours).

FIG. 12 is a graph of SCN⁻ concentration in extracts obtained from field soils at various depths sampled at the noted times (days) after Sinapis alba meal amendment.

FIG. 13 is a graph of SCN⁻ concentration in soil extracts obtained from soils at various depths sampled at the noted times (days) after Brassica napus meal amendment to field soil.

FIG. 14 is a graph of SCN⁻ concentration in soil extracts obtained from soils at various depths sampled at the noted times (days) after Brassica juncea meal amendment to field soil.

FIG. 15 is a graph of the toxicity of S. alba seed meal extract to various crops and weeds.

### DETAILED DESCRIPTION

### I. Terms and Introduction

The following term definitions are provided to aid the reader, and should not be considered to provide a definition different from that known by a person of ordinary skill in the art. And, unless otherwise noted, technical terms are used according to conventional usage.

As used herein, the singular terms “a,” “an,” and “the” include plural referents unless context clearly indicates otherwise. Also, as used herein, the term “comprises” means “includes.” Hence “comprising A or B” means including A, B, or A and B. It is further to be understood that all nucleotide sizes or amino acid sizes, and all molecular weight or molecular mass values, given for nucleic acids or polypeptides or other compounds are approximate, and are provided for description. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including explanations of terms, will control. In addition, the materials, methods, and examples are illustrative only and not intended to be limiting.

In order to facilitate review of the various examples of this disclosure, the following explanations of specific terms are provided:

Derivative: A derivative is a biologically active molecule derived from a base structure.

Effective amount: An amount of bioactive agent that is useful for producing a desired effect.

Plant material: A whole plant or portion(s) thereof including but not limited to plant tissue, leaves, stems, roots, seeds, and/or flowers.

Purified: The term “purified” does not require absolute purity; rather, it is intended as a relative term. For example, a purified compound is one that is isolated in whole or in part from contaminants.

### II. Biopesticide Plant Materials

The present application is primarily directed to using plant material, processed plant material, composition comprising plant material, or composition comprising processed plant material as biopesticides. The present invention is particularly directed to using plant material from plants within the order Capparales, and the family Brassicaceae. Even more typically, the plant material is from the genera Brassica and Sinapis, particularly Sinapis. Representative species of Brassica include hirta and napus. Representative species of Sinapis include Sinapis alba and Sinapis arvenis, with Sinapis alba being a currently preferred plant useful for its biopesticidal properties.

### III. Ionic Thiocyanate Production

Another basis for determining plant material within the scope of the present invention is to select plant material that includes glucosinolates that produce ionic thiocyanate (SCN⁻). Thus, any plant material that produces glucosinolates in a high enough concentration to produce ionic thiocyanate in a biologically active concentration is within the scope of the present invention. More specifically, preferred plant material produces 4-hydroxybenzyl glucosinolate, or derivatives thereof, resulting in the production of ionic thiocyanate.

### IV. Glucosinolates and Glucosinolate Concentrations

Glucosinolates, found in dicotyledonous plants, are a class of organic anions usually isolated as potassium or sodium salts, but occasionally in other forms. For example, p-hydroxybenzyl glucosinolate is isolated as a salt complex with sinapine, an organic cation derived from choline. Features common to the class are a β-D-thioglucose moiety, a sulfate attached through a C═N bond (sulfonated oxime), and a side group (designated R) that distinguishes one glucosinolate from another. A general formula for glucosinolates is provided below.

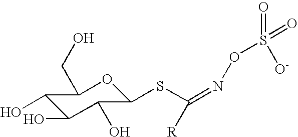

### Glucosinolate General Formula

More than 116 different R groups, and thus glucosinolates, have been identified or inferred from degradative products.

Glucosinolate types in plant species are highly variable. For example, the main glucosinolate in radish seed (Raphanus sativus) is 4-methylsulphinyl-3-butenyl glucosinolate, while mustard seed (Brassica juncea) is dominated by 2-propenyl glucosinolate. Cabbage seed (Brassica oleracea) contains mainly 2-propenyl and 2-hydroxy-3-butenyl glucosinolate. Rapeseed (Brassica napus) contains 4 major glucosinolates: 2-hydroxy-3-butenyl, 3-butenyl, 4-pentenyl, and 2-hydroxy-4-pentenyl. Similar differences in glucosinolate types are observed when comparing vegetative plant parts.

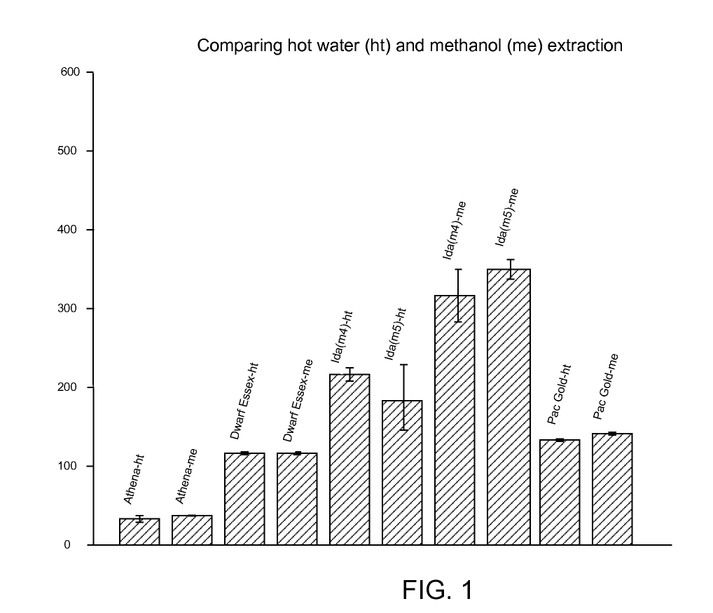

Brassica and Sinapis species, and many other members of the Brassicaceae plant family, produce glucosinolate compounds, which are secondary metabolites. Thus, the method may also comprise determining plants potentially useful for practicing disclosed embodiments of the present invention by choosing plants that produce glucosinolates in amounts effective for use as a biopesticide. Glucosinolates are compounds that occur in agronomically important crops and may represent a viable source of allelochemic control for various soil-borne plant pests. Glucosinolates can be extracted from plant material using aqueous extractions, using polar organic compounds, such as lower alkyl alcohols as the solvent, or by using aqueous mixtures of polar organic compounds to perform extractions, as illustrated by FIG. 1.

Glucosinolates are normally stored within plant tissues. Toxicity is not attributed to intact glucosinolates. Upon tissue damage, enzymes within the plant trigger their hydrolysis to several compounds including nitriles, isothiocyanates (ITCs), organic cyanides, oxazolidinethiones, and ionic thiocyanate (SCN⁻), that are released upon enzymatic degradation by myrosinase (thioglucoside glucohydrolase, EC 3.2.3.1) in the presence of water as indicated below in Scheme 1. Toxicity is not attributed to intact glucosinolates, but instead to biologically active products such as ITCs, organic cyanides, oxazolidinethiones (OZTs), and ionic thiocyanate (SCN⁻) released upon enzymatic degradation by myrosinase (thioglucoside glucohydrolase, EC 3.2.3.1) in the presence of water. Degradation also occurs thermally or by acid hydrolysis.

Myrosinase is not properly identified as a single enzyme, but rather as a family or group of similar-acting enzymes. Multiple forms of the enzymes exist, both among species and within a single plant, and all perform a similar function. Although their genetic sequences are similar to other β-glycosidases, myrosinases are fairly specific toward glucosinolates. These enzymes cleave the sulfur-glucose bond regardless of either the enzyme or substrate source. However, the particular enzyme and glucosinolate substrate influence reaction kinetics.

Myrosinase and glucosinolates are separated from each other in intact plant tissues. Evidence suggesting that myrosinase is a cytosolic enzyme associated with membranes, perhaps surrounding a vacuole containing glucosinolates, has been supplanted by that obtained using more precise methodologies. Glucosinolates are probably contained in vacuoles of various types of cells. In contrast, myrosinase is contained only within structures, called myrosin grains, of specialized myrosin cells that are distributed among other cells of the plant tissue. Myrosinase activity and glucosinolates are preserved in cold-pressed meal and are no longer physically separated. Thus, adding water immediately results in the production of the hydrolysis products, including isothiocyanate, without the need for additional tissue maceration.

Nitrile character is common to four additional products. Forming a nitrile (R—C≡N, also known as an organic cyanide), which does not require rearrangement, involves sulfur loss from the molecule. Nitrile formation is favored over ITC at low pH, but occurs in some crucifers at a pH where ITC is normally the dominant product. The presence of Fe⁺² or thiol compounds increases the likelihood of nitrile formation. Epithionitrile formation requires the same conditions as for nitriles, plus terminal unsaturation of the R-group and the presence of an epithiospecifier protein. The epithiospecifier protein possesses a rare property in that it is an enzyme cofactor that allosterically directs an enzyme to yield a different product. Thiocyanate (R—S—C≡N) is sometimes produced, particularly in members of the Alyssum, Coronopus, Lepidium, and Thlaspi families. Factors controlling organic thiocyanate formation are not well understood.

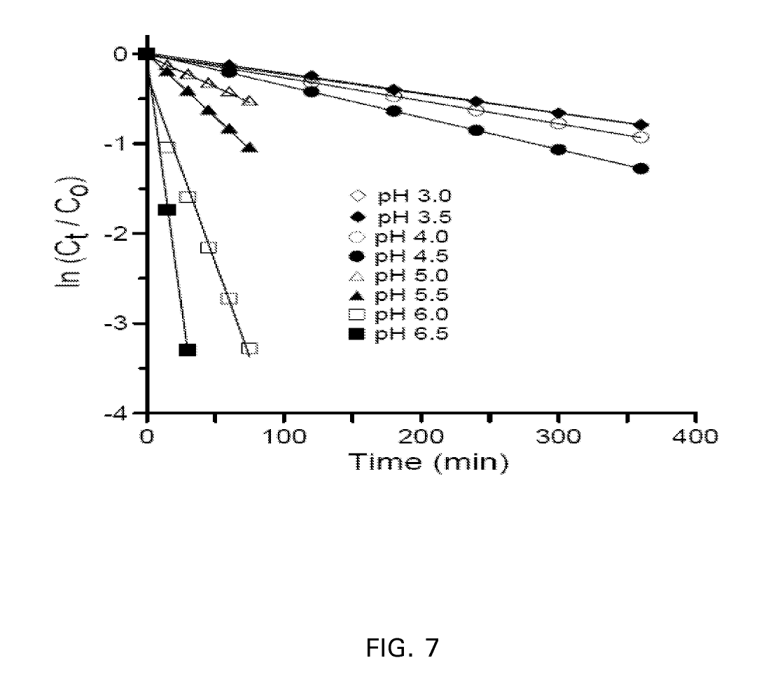

SCN⁻ production from glucosinolates is controlled by the presence of specific R-groups. Evidence suggests the anion is a resonance hybrid with greater charge on the S; however, charge can be localized on either the sulfur (⁻S—C≡N) or the nitrogen (S═C═N⁻), depending on the environment. Indole and 4-hydroxybenzyl glucosinolates yield SCN⁻ thought to arise from a highly unstable ITC intermediate. SCN⁻ is formed from indole glucosinolates over a wide pH range, whereas 4-hydroxybenzyl glucosinolates is typically thought to yield SCN⁻ only at a more basic pH. As discussed below and in the working examples, 4-OH benzyl isothiocyanate is not stable even at pH values of 3.0. The half-life decreases with an increase in pH from 3.6 hours at pH 3.0 to less than 5 minutes at pH 7.0 (FIG. 7).

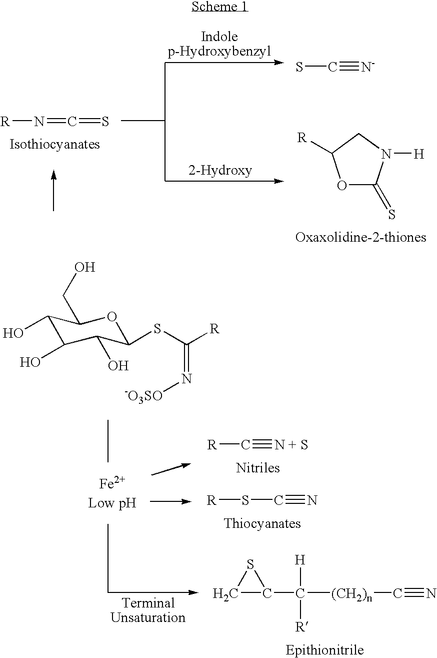

ITCs historically have been considered the ‘normal’ products of glucosinolate breakdown. They often are volatile with pungent flavors or odors. Some of the hydrolysis products, like ITCs, exhibit biocidal properties on insects, nematodes, fungi and/or weeds. ITC formation requires that the initial unstable aglucon intermediate undergo a Loessen rearrangement to the R—NCS configuration. Isothiocyanates are quite reactive, although less so than the related isocyanates (R—N═C═O). A few commercially available soil fumigants depend on the activity of methyl ITC either as the parent compound or as produced from precursors such as sodium N-methyldithiocarbamate or tetrahydro-3,5-dimethyl-2H-1,3,5-thiadiazine-2-thione. Because of known toxicities, ITCs are often considered likely candidates for pesticidal activity.

For Sinapis alba, the glucosinolate precursor to bioactive compounds is 4-hydroxybenzyl glucosinolate. Thus, the amount of this compound found in plants provides another basis for determining plant material useful for practicing embodiments of the disclosed invention. The structural formula for 4-hydroxybenzyl glucosinolate is provided below.

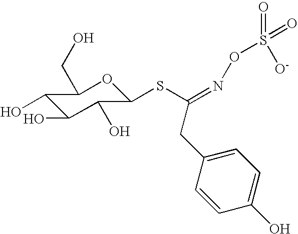

### 4-hydroxybenzyl glucosinolate

A person of ordinary skill in the art will appreciate that certain derivatives of 4-hydroxybenzyl glucosinolate also potentially may be useful for practicing disclosed embodiments of the present invention. For example, naturally occurring or synthetic derivatives may include plural hydroxyl groups, as opposed to the single hydroxyl group present at the 4 position in 4-hydroxybenzyl glucosinolate. Such derivatives might have a chemical formula

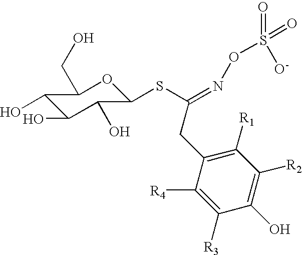

where one or more of R₁, R₂, R₃ and R₄ optionally are hydroxyl groups. It also will be appreciated that the hydroxyl groups present in 4-hydroxybenzyl glucosinolate, or derivatives thereof, may be present in some other form, such as a protected form, that produces the desired hydroxyl groups, such as by hydrolysis or enzymatic cleavage. Moreover, halide derivatives also may be useful. As a result, one or more of R₁, R₂, R₃ and R₄ optionally may be a halide. Benzyl glucosinolates substituted in the meta position (3-OH benzyl glucosinolate) or those with functional groups that prevent electron delocalization (4-methoxybenzyl glucosinolate) will degrade to more stable isothiocyanates. The stability of the isothiocyanate may be important for the use of seed meal products in pest control given the differences in biological activities of the glucosinolate hydrolysis products.

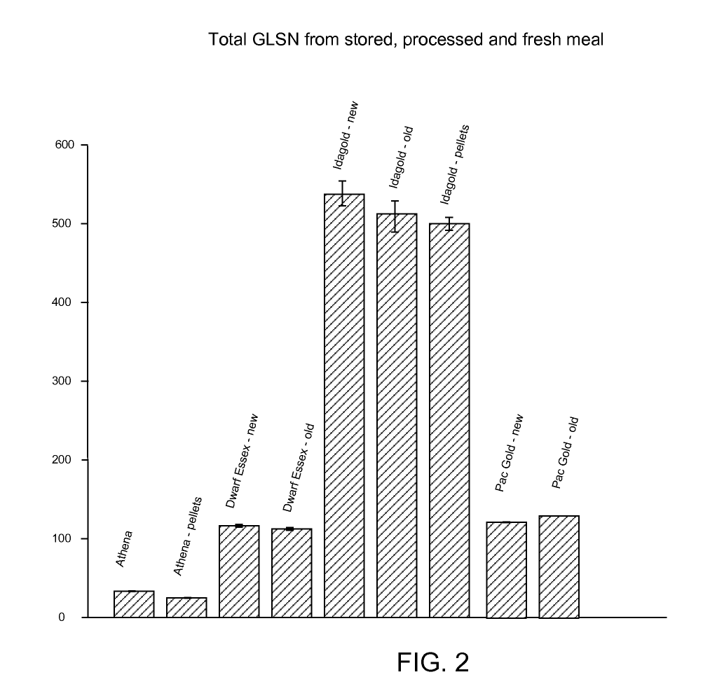

The concentrations of 4-hydroxybenzyl glucosinolate in plant material correspond to the amounts of ionic thiocyanate (SCN⁻) produced by such materials. A standardized methodology is used to quantitatively determine amounts of such bioactive compounds. This is the subject of Guidelines for Glucosinolate Analysis in Green Tissues for Biofumigation, Agroindustria, Vol. 3, No. 3 (2004), which is incorporated herein by reference. This publication discusses modifications of the ISO 9167-1 method, initially set up for evaluating rapeseed seeds, with the objective of optimizing and standardizing glucosinolate analysis in fresh tissues (leaves, roots or stems) of Brassicaceae. Collection, storage and preparation of fresh samples suitable to be analyzed are important steps during which it is necessary to avoid glucosinolate hydrolysis by the endogenous myrosinase-catalyzed reaction. Differences in glucosinolate concentrations in stored, processed and fresh meal are illustrated by FIG. 2.

For disclosed embodiments of the present invention, 4-hydroxybenzyl glucosinolate concentrations were determined using HPLC/MS. Additional information concerning determining glucosinolate concentrations is provided below in the working examples, using an internal standard, such as 4-methoxy benzyl glucosinolate. In summary, the concentration of the 4-hydroxybenzyl glucosinolate is measured, such as by determining the area under the appropriate HPLC peak. The concentration is multiplied by a response factor of 0.5 relative to 2-propenyl glucosinolate to determine the concentration of 4-hydroxybenzyl glucosinolate.

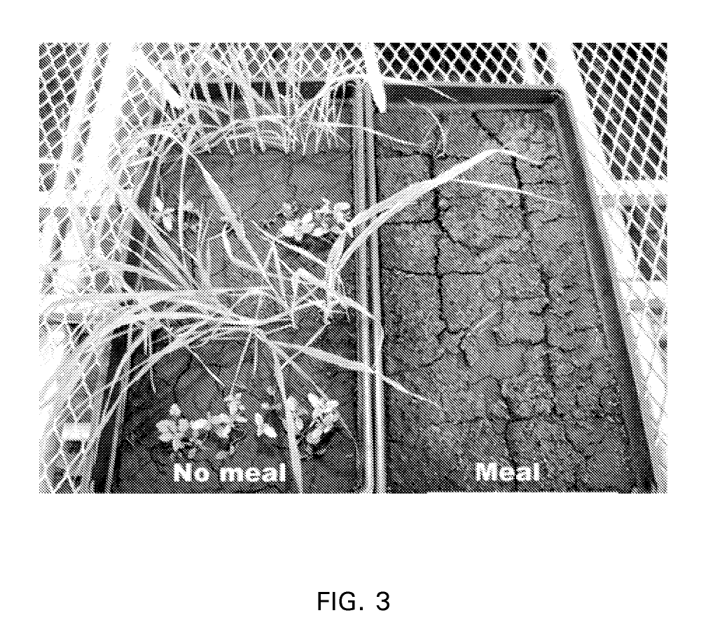

Certain embodiments of the present invention concern plant material having effective amounts of 4-hyroxybenzyl glucosinolate. The glucosinolate concentration typically is determined after plant material has been cold pressed to remove a majority of the plant oil. Residual oil contents for cold pressed plants typically range from substantially 0% to about 15%, more typically from 7% to 12%. If solvent extraction is used for oil removal, oil contents may be less than 1%. Glucosinolate concentrations may vary within plants of a single species, and concentration fluctuations may occur within a particular plant. Additional environmental factors such as spacing, moisture regime, and nutrient availability also may affect concentration. Nevertheless, useful 4-hydroxybenzyl glucosinolate amounts are from about 10 μmol/gram to about 500 μmol/gram, typically from about 10 μmol/gram to about 400 μmol/gram, more typically from about 50 μmol/gram to about 250 μmol/gram, and even more typically from about 75 μmol/gram to about 210 μmol/gram. Concentrations within these stated ranges have proved useful for controlling and/or suppressing weed formation in plant growth studies. FIG. 3 is an image illustrating the effects of Sinapis alba for weed production beside a control in a greenhouse trial.

### V. Seed Meal

Portions of plant material, leaves, stems, roots and seeds that have the highest concentration of 4-hydroxybenzyl glucosinolate commonly are used to practice embodiments of the disclosed process. Meal is preferably made from seeds; however it is possible to use any plant material containing 4-hydroxybenzyl glucosinolate to make the meal. For example, with reference to the exemplary Sinapis alba plant material, it has been found that the seeds contain the highest levels of 4-hydroxybenzyl glucosinolate. Sinapis alba is useful for making biodiesel. In a working embodiment, biodiesel production crushes the seeds, to liberate the oil, leaving the seed meal as a by-product. This by-product had limited use prior to development of the present invention. The seed meal now can be used to practice embodiments of the presently disclosed process.

### VI. Compositions

Plant material, or composition comprising plant material as disclosed herein can be used without prior processing, but typically are processed, such as by being pressed or crushed to produce a processed plant material. Suitable plant tissues optionally can be used in other forms. For example, Sinapis alba can be processed into seed meal. Furthermore, the seed meal can be pelletized by extruding through an extruder commonly used to produce seed meal pellets. These seed meal pellets also can be applied, as opposed to applying the plant products as processed.

Furthermore, plant products according to the present invention also can be formulated with other materials to facilitate useful fumigant attributes, or to facilitate other processes, such as fertilization processes. SCN⁻ often works synergistically with other chemicals. For example, use with certain peroxides produces bacteriocidal solutions, although neither is effective alone. Similarly, SCN⁻ was more efficient in lysing cells when combined with other anions or lysozymes than when any agent was used alone at the same concentrations.

Thus, plant material, processed plant material, composition comprising plant material or composition comprising processed plant material disclosed herein can be combined with other materials, natural and/or synthetic, inert and/or active, to produce useful fertilizing and/or fumigant compositions. A partial list of such materials include inert materials, such as binders, colorants, and/or pH adjusters/stabilizers; active compounds, such as naturally derived pesticide materials including capsaicin, onions, Neem tree materials, or compositions derived therefrom, such as Bacillus thuringiensis, microorganisms such as pseudomonads, peroxides, synthetic herbicides, surfactants and combinations thereof.

Furthermore, plant material, processed plant material, composition comprising plant material or composition comprising processed plant material of the present invention also can be formulated with other materials to provide essential plant nutrients, such as phosphorus. With respect to nitrogen, the seed meal of Sinapis alba, for example, provides high concentrations of nitrogen (5-6% on a weight basis), and hence added nitrogen is not required.

### VII. Methods for Using

Once disclosed compositions are obtained, they are then applied as needed and desired to take advantage of their biopesticidal properties. For example, disclosed plant material, processed plant material, composition comprising plant material, and composition comprising processed plant material, can be applied as surface applications, such as bare soil prior to planting. As used herein, “surface application” refers to applications that penetrate only the top portion of a soil, such as about 0.1 inch (about 0.25 centimeter) of the soil.

Alternatively, plant material, processed plant material, composition comprising plant material, or composition comprising processed plant material, of the present invention can be “surface incorporated”. “Surface incorporated” includes incorporating the plant material, processed plant material, composition comprising plant material, or composition comprising processed plant material into the soil to a depth of approximately 5 centimeters.

In preferred embodiments, the amount of water applied following application of compositions of the present invention is controlled. It has been found that no bioactivity may result from application of materials disclosed herein if too much water is supplied. Greenhouse experiments showed that the most extensive weed control occurred when sufficient water was added to the meal to promote hydrolytic reaction, but not so much as to leach the water soluble herbicidal anion (SCN⁻) out of the soil. Greenhouse tests conducted in field soil showed that ⅛ inch of water gave better weed control than higher water amounts up to and including 0.75 inch of water, more typically 0.5 inch of water. Greenhouse tests also showed that top dressing or amending the meal to the soil surface was just as effective at controlling weeds as incorporating into the top 2 inches of soil. This is consistent with the concept that the herbicidal compound is the water soluble SCN⁻. It is also consistent with the fact that most soils have a cation exchange capacity or a net negative charge.

Again without limiting the present invention to a theory of operation, it also is beneficial to control the pH for maximizing bioactivity of plant material, processed plant material, composition comprising plant material, or composition comprising processed plant material.

Certain food crops are resistant to active compounds provided by plant material, processed plant material, composition comprising plant material, or composition comprising processed plant material. As a result, the method also can include applying such plant material, processed plant material, composition comprising plant material, or composition comprising processed plant material, at the same time as food crops are planted. Alternatively, the method can include applying such plant material, processed plant material, composition comprising plant material, or composition comprising processed plant material, after emergence of food crops. For example, carrot seeds in both pelleted and unpelleted form germinate in the presence of Sinapis alba meal when provided at concentrations sufficient to kill or significantly damage weeds, such as those specifically identified in this application. Carrots appear more “tolerant” to the SCN⁻ produced by S. alba meal as compared to such crops as lettuce.

### VIII. Pest Control

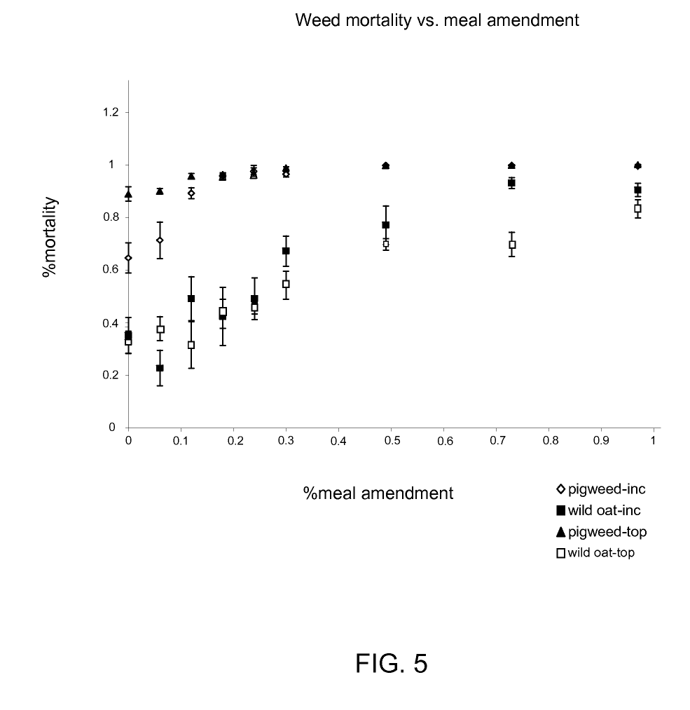

Embodiments of the present compositions, and methods for their use, can be used to control a variety of pests, such as weeds, fungi, bacteria, yeasts, insects, such as fungus gnats, weevils, flies, and nematodes, and combinations of such pests. For example, disclosed embodiments of the present invention, such as by using meal from various plant material, such as Sinapis alba meal, have been used in working embodiments to control a variety of weeds (FIGS. 3 and 5). Solely by way of example, and without limitation, a list of weeds that have been controlled using working embodiments of the present invention include prickly lettuce (Lactuca serriola), mayweed chamomile (Anthemis cotula), common lambsquarters (Chenopodium album), wild oat (Avena fatua), redroot pigweed (Amaranthus retroflexus), and combinations thereof. It is very likely that additional weeds will be controlled, and studies are ongoing to fully elucidate the biopesticidal scope of disclosed embodiments.

### IX. Examples

### Example 1

This example provides detail concerning seed meal preparation, determination of glucosinolate concentrations in defatted meal, and release of 4-hydroxybenzyl glucosinolate from meal, and ionic thiocyanate production from 4-OH benzyl isothiocyanate.

All analyses and experiments were performed with meal remaining after seed from the S. alba cultivar IdaGold was cold pressed to remove approximately 90% of the oil. The remaining oil was removed by performing three extractions with petroleum ether that involved shaking 500 grams of the meal with 500 milliliters of petroleum ether and filtering through a Büchner funnel. The final filtration cake was washed with 250 milliliters of petroleum ether, allowed to air dry, and homogenized in a blender.

Sinalbin Content of the Meal. The glucosinolate concentration of the defatted meal was determined using a method similar to that of the International Organization of Standardization. Defatted seed meal was weighed (200 mg) into 15-mL extraction tubes to which 500 mg of 3-mm glass beads, 10 milliliters of 70% methanol/water solution, and 100 μL of internal standard (4-methoxybenzyl glucosinolate, obtained from meadowfoam (Limnanthes alba) seed meal) were added. The detector response factor for 4-methoxybenzyl glucosinolate was determined by comparison with known concentrations of 2-propenyl glucosinolate having an assumed response factor of 1.0. Extraction tubes were shaken for 2 hours on a reciprocal shaker and centrifuged for 5 min at 1073 g to precipitate the seed meal. The extract solution was transferred to columns containing 250 mg of DEAE anion exchanger and allowed to drain freely. The columns were washed twice with 1 milliliter of deionized water and finally with 1 milliliter of 0.1 M ammonium acetate buffer (pH 4.0). To the columns were then added 100 μL of a 1 mg/L sulfatase enzyme (Sigma-Aldrich, St. Louis, Mo.) solution and 100 μL of 0.1 M ammonium acetate buffer (pH 4.0). The columns were covered to prevent evaporation and allowed to stand with the enzyme for 12 hours, after which time the samples were eluted into HPLC autosampler vials with two consecutive 750-μL volumes of deionized water.

A Waters 2695 HPLC separation module coupled with a Waters 996 photodiode array detector (PDA) and Thermabeam Mass Detector (TMD) was used for glucosinolate analysis. For quantitative purposes all desulfoglucosinolates detected by PDA were measured at a wavelength of 229 nanometers. Separation was performed on a 250×2.00 mm, 5μ, 125 Å Aqua C18 column (Phenomenex, Torrance, Calif.). The flow rate was 200 μL/min, with a methanol gradient starting at 0.5% and increasing to 50%. Glucosinolates were identified using a combination of expected retention behavior (time, sequence) and mass spectra.

4-Hydroxybenzyl Isothiocyanate Release from S. alba Seed Meal. Ten grams of the defatted meal were weighed into polypropylene centrifuge tubes to which was added 40 mL of deionized water. In one set of triplicate samples we added 10 milliliters of ethyl acetate as the extractant and 1 μL of decane (Sigma-Aldrich, St. Louis, Mo.) as the internal standard immediately after mixing the meal with deionized water. The mixtures were shaken, maintained at 22±2° C., and samples removed periodically during a 96-hour incubation period. In a second set of triplicate samples, the addition of 10 milliliters of ethyl acetate and 1 μL of decane were delayed until 30 minutes prior to each respective sampling time. At each sampling time the mixture was centrifuged for 10 minutes at 1677 g and 250 μL of the supernatant was withdrawn for analysis. GC-MS analysis was performed using an HP 5890A gas chromatograph equipped with a 30 m×0.32 mm i.d., 0.25 μm film HP-5MS capillary column (Agilent Technologies) coupled to an HP 5972 mass detector. Ethyl acetate extracts were manually injected into a split/splittless port (250° C., 20 s split) and temperature of the GC oven was programmed from 65° C. (isocratic 3 minutes) to 270° C. (isocratic 5 minutes) at a rate of 15° C./minute. Average linear flow rate of He at 250° C. was 35 centimeters/minute. Data (total ion current) were corrected using decane as the internal standard and quantified using benzyl isothiocyanate as an external standard.

Extraction efficiencies for 2-propenyl, butyl, benzyl, and t-octyl isothiocyanates were determined by combining 10 μL of each in duplicate 40-milliliters deionized water samples. The samples were treated in the same manner as described above including both the immediate and delayed addition of ethyl acetate and decane. The amount of each analyte extracted using continuous or periodic extraction was determined using GC-MS as described for S. alba seed meal.

Stability of 4-Hydroxybenzyl Isothiocyanate in Buffered Media. Partially purified 4-hydroxybenzyl isothiocyanate was prepared by suspending 500 grams of S. alba seed meal in 2 liters of deionized water and extracting the mixture with 500 milliliters of ethyl acetate for 24 hours. The ethyl acetate extract was separated by decanting the top organic layer after centrifugation, dried with 100 g of anhydrous sodium sulfate over night, and concentrated under vacuum at laboratory temperature. The crude 4-hydroxybenzyl isothiocyanate extract was further purified by preparative column chromatography on silica gel (500 grams). Elution was achieved in a stepwise fashion using six 100-milliter aliquots of eluent composed of pentane and methylene chloride at ratios of 100:0, 80:20, 60:40, 40:60, 20:80, and 0:100. Content of 4-hydroxybenzyl isothiocyanate within the fractions was verified by GC-MS using instrumentation and conditions as described previously. Fractions containing 4-hydroxybenzyl isothiocyanate were combined and concentrated under vacuum at laboratory temperature producing a yellowish, viscous fluid displaying only 4-hydroxybenzyl isothiocyanate and pentane/methylene chloride solvent peaks in the GC chromatogram. No further concentration of 4-hydroxybenzyl isothiocyanate was achieved using vacuum distillation because of its instability.

The pH stability of 4-hydroxybenzyl isothiocyanate was analyzed by incubating 25 μL of partially purified extract dissolved in 25 milliliters of eight different buffers with pH values ranging from 3.0 to 6.5 (FIG. 7). 0.1 M buffers were used, and were prepared by mixing 0.2 M sodium citrate and citric acid solutions in pre-calculated ratios ranging from 4 milliliters sodium citrate and 46 milliliters citric acid to 41 milliliters sodium citrate and 9 milliliters citric acid in a total volume of 100 milliliters. Actual pH values of the buffers of 3.03, 3.52, 4.02, 4.49, 5.00, 5.46, 5.91, and 6.52 were verified using an Orion model 420A pH meter (Orion Research, Boston). At specific times during the incubation a 1-milliliter sample was withdrawn from the buffered reaction solution with a syringe and injected into a Waters Integrity HPLC system (2695 separation module, 996 PDA, and TMD) equipped with a 150×2 mm i.d., 5 μm Aqua C-18 column (Phenomenex). The instrument was operated at a constant flow rate of 200 μL/min with a gradient from 5 to 35% of methanol during each 30-minute run. Half-lives for 4 hydroxybenzyl isothiocyanate were estimated from straight lines obtained by plotting the natural logarithm of the normalized concentration versus time (FIG. 7). This experiment was repeated twice with two different meal extracts acquired by the same procedures from the same seed material. Half-lives from only one of the experiments are reported since the results for both experiments were similar.

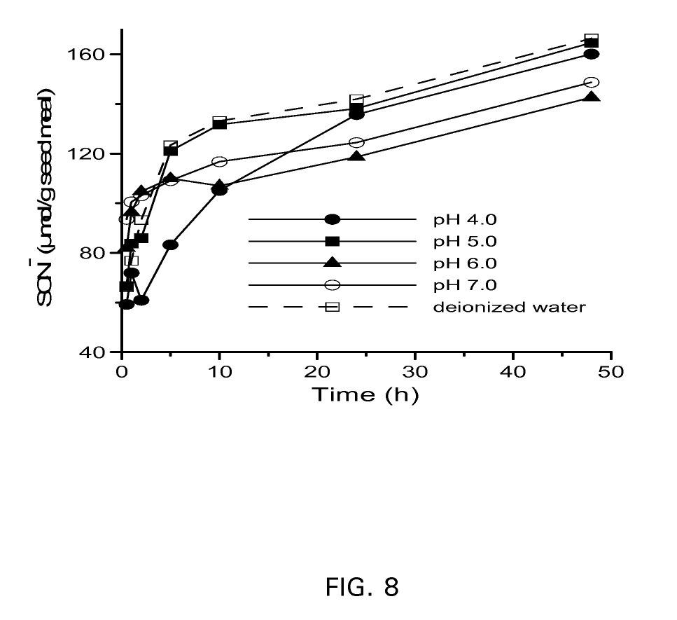

Release of SCN⁻ from S. alba Seed Meal. Ten grams of defatted S. alba meal were weighed into a 250-mL polyethylene bottle to which was added 200 milliliters of deionized water or a citrate buffer solution (pH of 4.0, 5.0, 6.0, or 7.0) prepared as described previously. The samples were placed on a reciprocating shaker for 48 hours during which time 5.0-milliliter aliquots were removed periodically to determine the time course of SCN⁻ release. Each 5-milliliter aliquot was placed in a 50-milliliter centrifuge tube and 40.0 milliliters of a methanol:deionized water (2:1, v:v) solution containing 1% acetic acid was added. The tubes were shaken vigorously for 15 minutes, centrifuged for 5 minutes at 1073 g, and 5 milliliters of the supernatant filtered through a 25-mm, 0.2-μm GD/X membrane (Whatman) into a beaker. One milliliter of the filtered sample was then transferred to an HPLC autosampler vial to which was added 0.50 milliliter of a 0.01 M Fe³⁺ solution and 100 μL of a 0.1 M HCl solution. The vials were capped, shaken, and immediately analyzed using a Waters Integrity HPLC system equipped only with a 5-μm, 10×2 mm i.d. Aqua C-18 pre-column (Phenomenex). A 50-μL sample was injected and isocratically eluted using a 10% methanol solution pumped at a flow rate of 0.5 milliliter/minute. Absolute concentrations of SCN⁻ in the unknown samples were determined following the same procedure as described above, except that 10.0 grams of S. alba meal from which the glucosinolates had been removed with repeated methanol extraction was substituted for the unaltered meal. Amounts of a KSCN stock solution containing 10 to 100 μmol of SCN⁻ were added to the meal/buffer mixtures prior to the initial shaking and a separate standard curve prepared for each buffer pH (FIG. 8).

Glucosinolates in S. alba Meal. As expected, sinalbin was the major glucosinolate in S. alba meal, constituting approximately 93% of total glucosinolate content. The measured concentration of sinalbin in defatted meal was 152±5.2 μmol/gram (mean value ± variance of five replicates). The meal also included (2R)-2-hydroxybut-3-enyl glucosinolate (3.6 μmol/g) and five unidentified glucosinolate peaks with a total estimated glucosinolate concentration of approximately 6.4 μmol/g. Concentrations of indolyl glucosinolates that could potentially produce SCN⁻ as a result of hydrolytic instability of their respective isothiocyanates represented a total of only about 1 μmol/g of defatted seed meal. Simplicity of the glucosinolate profile in S. alba meal thus facilitates our ability to determine a likely precursor for glucosinolate hydrolysis products that might be identified. Most important is the fact that low concentrations of indolyl glucosinolates eliminate the possibility that these compounds can serve as precursors of significant amounts SCN⁻ that might be measured in hydrolyzed extracts.

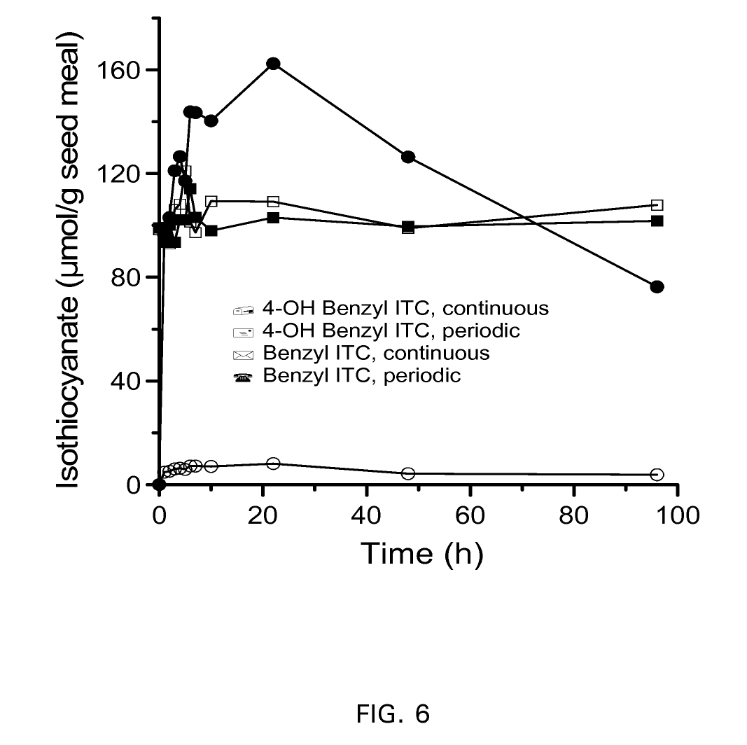

4-Hydroxybenzyl Isothiocyanate Release from S. alba Seed Meal. A dramatic difference was observed between the relatively high yield of 4-hydroxybenzyl isothiocyanate obtained by continuously extracting into ethyl acetate as compared to periodic measurements made by adding ethyl acetate 30 minutes prior to each respective sampling time (FIG. 6). Maximum 4-hydroxybenzyl isothiocyanate extracted during the continuous procedure was 162 μmol/gram seed meal at 24 hours, whereas less than 10 μmol/gram was extracted at any one time in the periodic analyses. In contrast, when continuous and periodic extractions were performed with benzyl isothiocyanate, comparable concentrations of the compound were measured in the ethyl acetate extracts irrespective of the procedure. 2-Propenyl, butyl, and t-octyl isothiocyanates showed extraction yields similar to that of benzyl isothiocyanate ranging from at least 98% for all isothiocyanates in the continuous extraction to a low of 83% for 2-propenyl isothiocyanate in the periodic extraction.

These results establish that 4-hydroxybenzyl isothiocyanate is unstable in aqueous media, and that isolation and purification require the use of non-reactive solvents.

Stability of 4-Hydroxybenzyl Isothiocyanate in Buffered Aqueous Solutions. Partially purified and concentrated seed meal extracts containing 4-hydroxybenzyl isothiocyanate were dissolved in buffers ranging from pH 3.0 to 6.5. The half life of 4-hydroxybenzyl isothiocyanate at pH 6.5 was the shortest at 6 minutes, increasing to 16, 49, 100, 195, 270, 312, and 321 minutes with decreasing pH values of 6.0, 5.5, 5.0, 4.5, 4.0, 3.5, and 3.0, respectively (FIG. 7). Hydrolytic instability of 4-hydroxybenzyl isothiocyanate, especially at higher pH values, explains its low extractability in unbuffered extracts of seed meal that had a pH of 5.3 and a sampling time of 48 hours. Appreciable hydrolysis occurs at pH values as low as 3.0 and in a soil environment buffered at pH values typically between 5 and 7, significant amounts of SCN⁻ production are expected in a relatively short time period.

Ionic Thiocyanate Release from S. alba Seed Meal. S. alba seed meal was incubated with deionized water and buffer solutions ranging from pH 4.0 to 7.0 to quantify SCN⁻ production resulting from 4-hydroxybenzyl glucosinolate hydrolysis in the presence of a full component of meal constituents (FIG. 8). SCN⁻ production occurred most slowly at pH 4.0, but final concentrations determined at 48 hours varied from a low at pH 6.0 of 143 and a high in deionized water of 166 μmol/gram seed meal. The amount of SCN⁻ expected based on 4-hydroxybenzyl glucosinolate concentration in the meal and the assumption of its complete stoichiometric conversion to SCN⁻ is approximately 152 μmol/g seed meal, thus indicating near complete conversion in 48 hours at all pH values.

Results obtained with seed meal incubations confirm conclusions reached using 4-OH benzyl glucosinolate extracts, clearly indicating that 4-hydroxybenzyl isothiocyanate is rapidly hydrolyzed to SCN⁻ at pH values expected in most soils. In contrast, data from previous investigations conducted with purified sinalbin and myrosinase indicate that decreased pH values promote the formation of 4-hydroxybenzyl cyanide at the expense of 4-hydroxybenzyl isothiocyanate, thereby decreasing subsequent formation of SCN⁻ by approximately 50% at pH 3.0 as compared to pH 7.0. The presence of additional meal components moderates the influence of pH on the production of 4-hydroxybenzyl cyanide, thus preserving SCN⁻ formation. Application of S. alba seed meal to soil with the addition of sufficient water to promote glucosinolate hydrolysis is expected to produce an amount of SCN⁻ stoichiometrically equivalent to the amount of 4-hydroxybenzyl glucosinolate within the meal.

SCN⁻ production in soils amended with S. alba seed meal has significant consequences with respect to phytotoxicity and the use of meal as a bioherbicide. The herbicidal activity of SCN⁻ is well known and commercial formulations containing NH₄SCN have been marketed. Amendment rates necessary for weed control have been determined by a number of investigators for NH₄⁺, K⁺, and Na⁺ salts with complete removal of all vegetative cover reportedly occurring for a period of 4 months when SCN⁻ was applied at rates of 270 to 680 kg/ha (Ahlgren, G. H.; Klingman, G. C.; Wolf, D. E. Principles of Weed Control; John Wiley & Sons: New York, 1951). Higher rates of 1,366 kg SCN⁻/ha were necessary for complete plant kill for 4 months, but a large percentage of the weeds were removed with only 137 kilograms/SCN⁻ ha (Harvey, R. B. J. Am. Soc. Agron. 1931, 23, 944-946). Bissey and Butler (J. Am. Soc. Agron. 1934, 26, 838-846) tested application rates that might alter wheat germination, finding that 342 kilograms SCN⁻/ha caused inhibition, but that the effect was no longer observed at 69 days post application. Solutions of SCN⁻ sprayed directly on vegetative growth showed that cotton defoliation was possible using only 8.6 kilograms SCN⁻/ha (Harvey, R. B. J. Am. Soc. Agron. 1931, 23, 944-946).

Amounts of SCN⁻ contributed from S. alba seed meal used here, assuming complete stoichiometric conversion, would amount to 8.8, 17.7, and 35.3 kg SCN⁻/ha for amendment rates of 1000, 2000, and 4000 kilograms meal/ha, respectively. Although glucosinolate concentrations in the S. alba meal used were not reported, Ascard and Jonasson (In Weeds and Weed Control, Reports; 32 Swedish Crop Protection Conference; Swedish University of Agricultural Sciences: Uppsala, 1991; pp 139-155) observed weed control effects with application rates of 1000 to 2000 kilograms/ha. Phytoxicity also has been observed towards weed and crop species when meal was amended to greenhouse or field soils at rates from 1000 to 4000 kilograms meal/ha (unpublished data), thereby providing the impetus for the work reported here. SCN⁻ rates provided in S. alba meal, although not as high as those used previously in phytotoxicity studies with soluble salts, provide SCN⁻ in amounts of potential value in weed control.

In addition to weed control benefits afforded by SCN⁻ produced as a result of glucosinolate hydrolysis, the meals contain between 5 and 6% N that when mineralized represents an important nutrient source to crop plants. Organic agriculture may thus benefit from the use of S. alba meal as a soil amendment both through weed control and as a nutrient source. Potential environmental effects appear minimal given that biological degradation of SCN⁻ has been observed in soils and S. alba is typically grown as a condiment mustard for human consumption.

Glucosinolate concentrations in Brassicaceae seed meals as may be determined according to the method of this example are shown in Table 1 below.

TABLE 1
Glucosinolate concentrations in Brassicaceae seed meals.

| | | | | B. juncea |
|---|---|---|---|---|
| | B. napus | B. napus | S. alba | “Pacific |
| | “Athena” | “Sunrise” | “Ida Gold” | Gold” |
| Glucosinolate R-group | μmol g⁻¹ of sample | | | |
| (2R)-2-hydroxy-3- | 1.5 | 1.3 | 3.4 | 0.5 |
| butenyl | | | | |
| 2-propenyl | | | | |
| (2S)-2-hydroxy-3- | 0.4 | | | 123.8 |
| butenyl) | | | | |
| 2-hydroxy-4-butenyl) | 0.2 | | 1.8 | |
| (2R)-2-hydroxy-4- | | | | 0.5 |
| pentenyl | | | | |
| 4-hydroxy-benzyl | | | 148.1 | |
| Unknown | | | 9.1 | |
| 3-butenyl | 2.8 | 2.7 | | |
| 4-hydroxy-3- | 11.3 | 10.9 | | 0.74 |
| indolylmethyl (0.28) | | | | |
| unknown | | | 2.6 | |
| unknown | | | 0.74 | |
| 4-pentenyl | 1.3 | 1.4 | | |
| 3-indolylmethyl | 0.9 | 0.8 | | |
| 4-methylthiobutyl | 1.7 | | | |
| N-methoxy-3- | | 0.1 | 0.01 | 0.6 |
| indolylmethyl | | | | |
| unknown | | | | 1.33 |
| TOTAL | 20.1 | 17.2 | 165.75 | 126.14 |

Highest glucosinolate concentrations were measured in S. alba IdaGold meal with 4-OH benzyl showing as the dominant glucosinolate. The B. juncea variety Pacific Gold had the next highest glucosinolate concentration, with propenyl glucosinolate dominating the total. Literature references indicate that both 4-OH benzyl and propenyl glucosinolates produce ITC as an end product of hydrolysis at typical soil pH values.

More recent evidence indicates that this assumption is not true for 4-OH benzyl glucosinolate. ITC production is significant since this compound is considered to be the most toxic of all glucosinolate hydrolysis products and thus most important in pest control. Recent results with weed seed bioassays prompted a reevaluation of this assumption and further prompted considering the inhibitory properties of other compounds, such as ionic thiocyanate.

The remaining B. napus varieties, Athena and Sunrise, were included as they routinely are used as an amendment in bioassay control experiments, and only low glucosinolate concentrations were present.

### Example 2

This example concerns the effects of processing and storing disclosed compositions. In an effort to facilitate dispersal of meal in future applications a pelletization trial was conducted for several seed meals. Equipment used for pelleting grains into animal feed was used to form pellets comprising small amounts of both Athena and IdaGold seed meal. This process normally includes a step of exposing the stock material to high-temperature steam, which aids in producing a stable pellet; however, this step was excluded to retain intact glucosinolates within the meal. The end product extruded was a relatively stable pellet having a diameter of 0.4 cm and a length ranging from 1-3 cm. With this shape, these pellets would theoretically allow the material to be applied with existing equipment and without using special modifications.

Once sample pellets were obtained, they were reground to form a fine powder and the glucosinolate profile was compared to the stock meal used to make pellets. Additionally the total glucosinolate content of older stocks of B. napus Dwarf Essex, S. alba IdaGold, and B. juncea Pacific Gold meal from previous harvests in 2001 were compared to the same meals produced during 2002. This comparison was conducted to determine if significant amounts of glucosinolates were lost during storage for up to a year. With the exception of Athena, neither the process of converting meal flakes into pellets, nor storing the meal for approximately a year had much effect on the total glucosinolate content (FIG. 2). The comparison of old and new stocks of Dwarf Essex, IdaGold, and Pacific Gold meal revealed little difference in composition and heterogeneity. It is likely that variability could be attributed to different environmental conditions experienced between growing seasons of the two harvests. Timing of moisture, growing degree days, and level of damage from insects each could have affected the final glucosinolate profile of the harvested seed. The process of producing pellets from the meal had no detrimental effect on the glucosinolate content, and the intense physical homogenization which occurs prior to the extrusion of the pellets appeared to decrease the final variability of total glucosinolates within the IdaGold meal.

### Example 3

This example concerns isothiocyanate release from cold pressed meals. Glucosinolate hydrolysis is necessary for ITC release. Only a portion of the glucosinolate is actually converted to ITC. Initial efforts were thus directed towards quantifying the proportion of ITC produced relative to the original glucosinolate concentration. The effectiveness of modifying meal products to enhance ITC release can thus be determined by monitoring for an increase in release efficiency.

Ten grams of meal were mixed with 40 milliliters of deionized water and 10 milliliters of ethyl acetate containing 1 μl decane as an internal standard. The mixture was shaken and samples were removed periodically during a time period of 96 hours. Analysis of the samples was performed used GC-MS. An HP 5890A gas chromatograph coupled with an HP 5972 series A mass Detector was used, along with a DB-5 capillary column (30 in×320 pm, 0.25 pm film). Ethyl acetate extracts were manually injected into a split/splitless port (250 liters, 20 seconds split), and the temperature of the GC oven was programmed from 65° C. (iso 3 minutes) to 270° C. (iso 5 minutes) with a rate 15° C./minute. Average linear flow rate of He at 250° C. was 35 cm/minute. Quantification of data (total ion current) was performed using decane as internal standard in all samples and calibration with benzyl isothiocyanate. Isothiocyanate release efficiency in the form of a percentage was calculated using the following equation.

Release efficiency=(Isothiocyanate/Glucosinolate)×100

Stoichiometry for glucosinolate hydrolysis shows that each mole of glucosinolate is expected to release 1 mole of ITC. Release efficiencies lower than 100% will occur when ITC amounts are less than glucosinolate amounts within the respective meal.

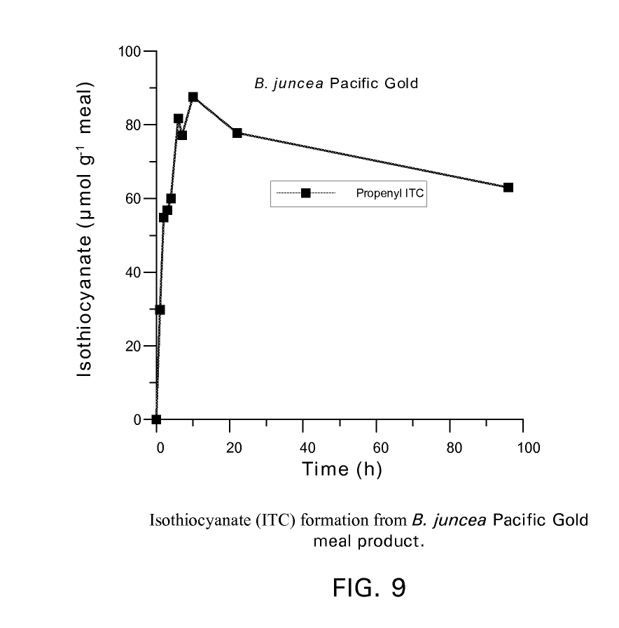

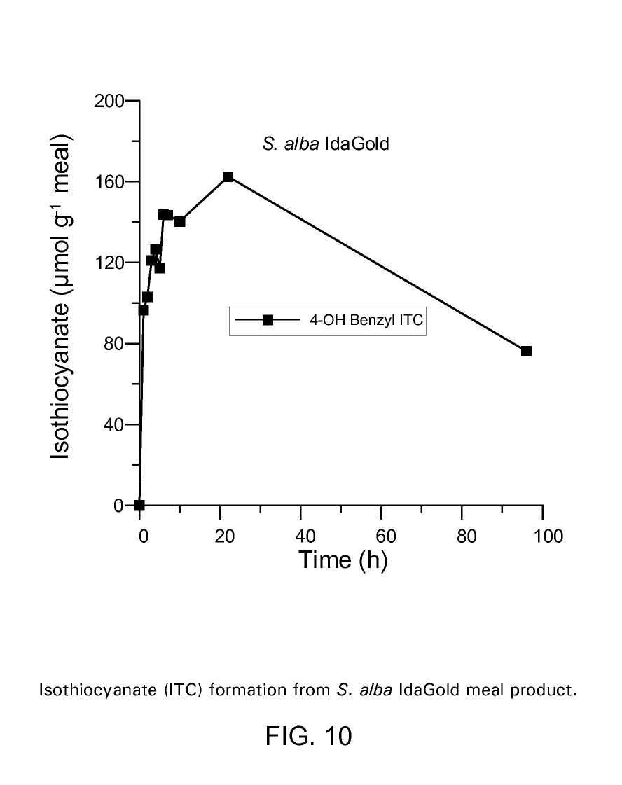

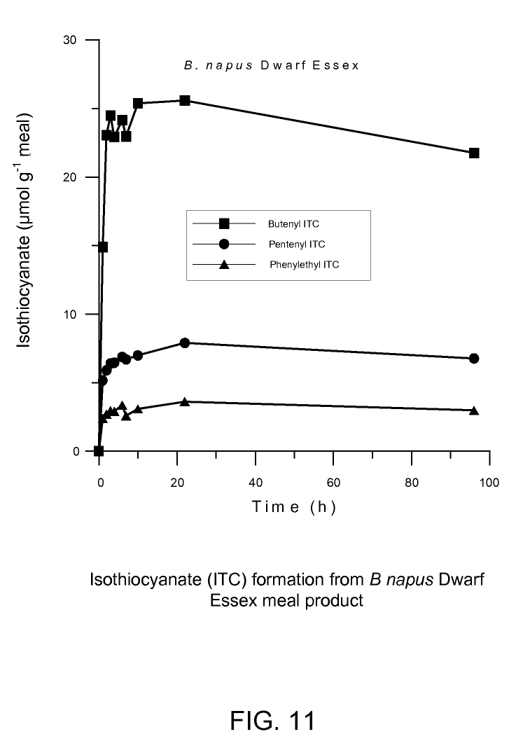

FIGS. 9-11 provide time release curves. FIG. 9 provides a time release curve for propenyl ITC from B. juncea Pacific Gold meal. Maximum ITC release of 88 μmol/gram seed meal occurred at 10 hours. This amount of ITC is equivalent to a release efficiency of 80%. Thus 80% of the glucosinolate potentially available was actually measured as ITC. FIGS. 10 and 11 provide the ITC release curves for S. alba IdaGold and B. napus Dwarf Essex. The ITC release efficiency from S. alba IdaGold is 29% (FIG. 10) and that for B. napus Dwarf Essex is 65% (FIG. 11). Increased release efficiencies translate into more effective pest control.

Release efficiency data indicate that little benefit exists for attempting to enhance propenyl release from B. juncea meal. Greater benefit may be realized by increasing ITC release from S. alba meal since the release efficiency was only 29%. However, the meal already contains high 4-OH benzyl concentrations that may reduce the need for such enhancement. In addition, for S. alba it is quite possible that release efficiency is not the only contributing factor to the measured low ITC concentrations. Measured concentrations are a function of opposing ongoing processes that include both ITC production and ITC dissipation. For S. alba, dissipation may occur at a relatively high rate, thus decreasing the mass of ITC accumulating in the medium. This indeed is what was observed to occur. 4-OH Benzyl isothiocyanate is unstable and thus is degraded to form SCN⁻.

### Example 4

We observed no effect of S. alba meal on soil insects and nematodes. The lack of a biological response with S. alba meal was puzzling given the fact that this meal contained the highest concentration of glucosinolate, that being predominantly 4-OH benzyl. It was assumed that ITC formed from 4-OH benzyl glucosinolate is stable unless subjected to strong alkali, at which time it is hydrolyzed and SCN⁻ is formed. Release efficiency data indicate that such thinking may not accurately reflect 4-OH benzyl ITC behavior.

The pH stability of 4-OH benzyl ITC was assayed by incubating it in 5 buffer solutions (sodium acetate/acetic acid from pH range 3 to 5 and monosodium phosphate/phosphatic acid for pH above 5) with pHs ranging from 3.0 to 7.0. At specific times during the incubation a sample from the incubated solution was withdrawn with a syringe and injected into an HPLC-PDA (Waters Integrity system, separation module 2695, photodiode array detector 996, column Phenomenex Aqua C-18, 5 μm, 150×2 mm, with a constant flow rate of 200 μl/minute gradient from 5 to 35% of methanol in 30 minutes). The amount of 4-OH benzyl ITC was determined using calibration with benzyl ITC.

TABLE 2
Stability of 4-OH benzyl isothiocyanate at different pHs

| pH | Half Life (Minutes) |
|---|---|
| 3 | 216 |
| 4 | 126 |
| 5 | 90 |
| 6 | 6 |
| 7 | 4.8 |

4-OH benzyl isothiocyanate was not stable even at pH values of 3.0. The half life decreases with an increase in pH from 3.6 hours at pH 3.0 to less than 5 minutes at pH 7.0. Thus in a soil environment 4-OH benzyl ITC will be produced from S. alba meal but because it is unstable, will hydrolyze rapidly to produce ionic thiocyanate as shown below.

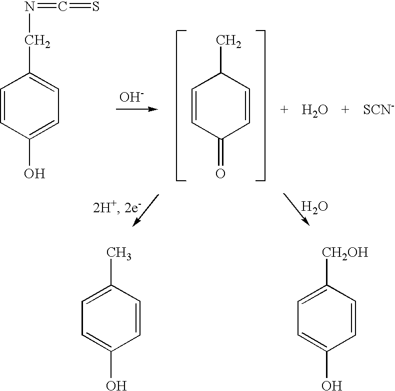

The lack of a negative effect on insects, nematodes, and fungi is caused by the rapid hydrolysis of 4-OH benzyl ITC. This instability may also contribute to the low release efficiencies that were measured. However, the fact that S. alba meal is an effective herbicide indicates that one of the hydrolysis products is responsible. Literature indicates that SCN⁻ is indeed phytotoxic and thus of likely importance in weed inhibition.

### Example 5

This example concerns determining soil pH effective for maintaining bioactivity of disclosed plant material, processed plant material, composition comprising plant material, or composition comprising processed plant material. Soil is sampled up to depth 35 cm using stainless steel soil probe of diameter 20 mm. Three replicate soil samples were taken from individual plots, and similar depths were merged into one soil sample. Soil cores for depth 0-5, 5-10, 10-15, and 15-25 centimeters were individually transferred into marked plastic storage bags for temporary storage.

Soil samples were homogenized by hand directly in storage bags, and transferred into pre-weighed and marked 250-mL PE bottles. After addition of 200 milliliters of extracting solution, (5 mmol/L solution of calcium chloride in DI water) and 1.00 milliliter of internal standard (100 mmol/L solution of potassium bromide in DI water) PE bottles were tightly closed, and shaken on reciprocating shaker for 60 minutes. PE bottles with shaken samples were left on a laboratory bench for another hour, to allow soil particles to sediment. It is possible to accelerate sedimentation using centrifugation. Supernatant from above was drawn into a 10-milliliter syringe, and immediately filtered into a marked autosampler vial using an in-line disposable filter (PVDF Filter media, 25 mm diameter, 0.45 μm pore size, Whatman, N.J., USA).

Approximately 10-gram soil samples from a particular depth profile were merged across the field and put into pre-weighed metal cans, and reweighed. The samples were then dried in an oven set at a temperature of about 120° C. until the samples had a constant weight.

Soil extracts were analyzed using ion chromatograph (Dionex, Sunnyvale, Calif., USA) in the following configurations and conditions: GP40 gradient pumps, ED40 electrochemical detector, and AS40 automated sampler, 250 μL sampling loop, gradient elution from 5 to 80 mmol/L potassium hydroxide in 15 minutes, column IonPacAS16, 4×250 mm, software PeakNet v 5.01.

A standard solution of 100 mmol/L of potassium thiocyanate in DI water was precisely diluted to obtain calibration solutions in a range from 1 μMol/L to 10 mmol/L. One milliliter of calibration solution was pipetted into 200 milliliters of extracting solution (5 mmol/L calcium chloride in DI water). Samples for all concentration levels were created in triplicates. Calibration solutions were analyzed exactly the same way as the field soil samples.

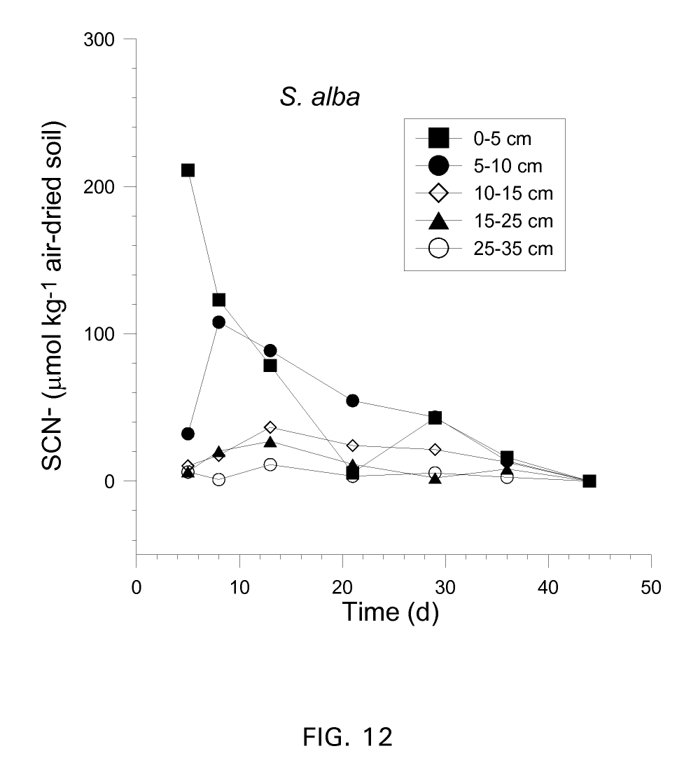

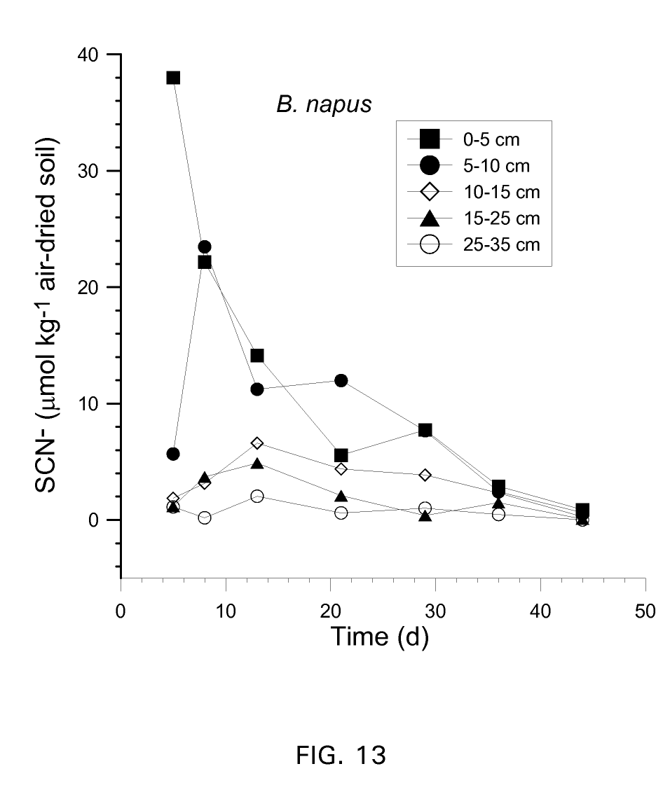

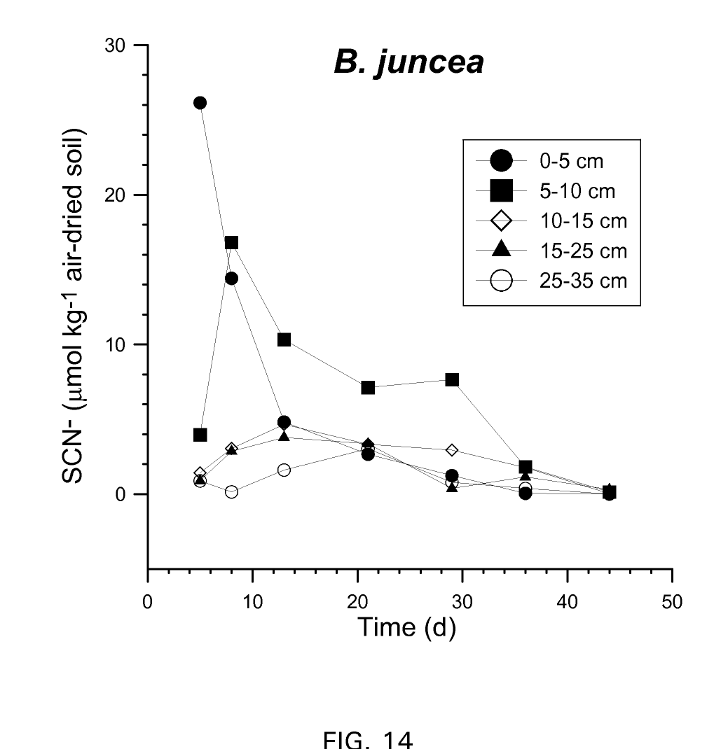

Data files were integrated automatically using PeakNet software supplied with instrument. All chromatograms were checked for missed or undetected peaks of thiocyanate anion, and when necessary, thiocyanate anion peaks were integrated manually. The same integration parameters were applied for field soil samples and for calibration solutions. A calibration curve was obtained by linear regression of thiocyanate peak areas versus thiocyanate concentrations. Concentrations of thiocyanate anion in soil samples were estimated using slope and constant value of linear regression of calibration data. Results, shown in FIG. 12 (S. alba), FIG. 13 (B. napus) and FIG. 14 (B. juncea) are expressed per one kilogram of dry soil, using known moisture content of the soil samples.

### Example 6

Sinapis alba meal was expected to have the greatest effect on fungus gnats. However, initial trials showed little response. The lack of a response prompted a reevaluation of the chemistry, eventually leading to the determination that S. alba is ineffective against insects because the isothiocyanate produced is unstable.

Fungus gnat control with cold pressed meal: Four different meals, B. juncea ‘Pacific Gold’, S. alba ‘IdaGold’, B. napus ‘Dwarf Essex’, and B. napus ‘Athena’, were used in a series of bioassay experiments to determine pesticidal behavior against fungus gnats. The effectiveness of volatiles in closed containers was determined in which the meal was physically separated from the test organism. Only volatiles from the wetted meal were allowed to contact the bioassay organism. The effect of meal incorporation and top dressing were also assessed in separate experiments. Specific details of each trial are shown below in Tables 3-12. These tables show data collected in preliminary experiments designed to determine the effects of meal volatiles on fungus gnat adults. B. juncea ‘Pacific Gold’ showed complete control, whereas S. alba ‘IdaGold’ was ineffective. The high glucosinolate B. napus ‘Dwarf Essex’ showed partial control and as expected, low glucosinolate B. napus ‘Athena’ had no effect on adult fungus gnat survival. Preliminary results with larvae were similar, except that Dwarf Essex showed no effect.

Meal incorporation into the potting medium showed similar trends with respect to fungus gnat toxicity. B. juncea meal showed complete fungus gnat control at a rate of 3%, whereas S. alba showed little impact at a rate of 6% (w:w). Nematodes were completely eliminated by B. juncea, but not S. alba meal.

Gnat larvae were killed by isothiocyanate volatiles from B. juncea, but not from B. napus or S. alba. This is in line with many of the other bioassays. Sinapis alba is not toxic to larvae. Volatiles produced from Brassica napus ‘Dwarf Essex’ or ‘Athena’ were not toxic. Either the volatiles were not produced or they were produced at levels that were below a threshold level of toxicity.

Fungus gnat survival was determined by counting the number of adults that emerged from the respective treatments. High glucosinolate B. napus and S. alba meals showed some control at rates of 10%, but never equivalent to that of B. juncea. Nematode survival in the potting mix also was determined, and only B. juncea completely eliminated nematodes.

With respect to fungus gnat larval survival for trials with larger numbers of replicates, the most effective treatment is B. juncea meal amendment at 3 and 6%. Decreased fungal gnat survival with amendment of B. napus Dwarf Essex and S. alba meals was determined, but even 6% amendment did not result in acceptable fungus gnat control.

With reference to the effect of meal top-dressing and minimal soil incorporation on the survival of fungus gnat larvae, significant decreases in emerging numbers of adult fungus gnats when B. juncea meal was either top-dressed or incorporated into the top 6-7 mm of potting mix. There was no difference between any of the 3% and 6% treatments.

TABLE 3
Fungus gnat adult volatile experiment¹ (n = 1)

| | number adults alive: | | |
|---|---|---|---|
| Treatment² | after 90 minutes | after 17 hrs | after 24 hrs |
| Peat moss (control) | 10 | 8 | 8 |
| B. juncea (Pacific Gold) | 0 | 0 | 0 |
| S. alba (IdaGold) | 10 | 8 | 5 |

¹Bioassay chamber consisted of a 50-dram snap-cap plastic vial, with 10 adults place in 9-dram snap cap vial with organdy top and drop of apple sauce for sustenance. Treatment material was placed at the bottom of the 50-dram vial.
²Treatments: 1) 0.75 g peat moss + 4 ml water; 2) 0.75 g Brassica juncea meal + 4 ml water; and 3) 0.75 g Sinapis alba meal + 4 ml water.

TABLE 4
Fungus gnat adult volatile experiment¹ (n = 2)

| | Mean number adults alive after: | | | | | |
|---|---|---|---|---|---|---|
| | 30 | 60 | 90 | 6 | 18 | 24 |
| Treatment² | min. | min. | min. | hrs | hrs | hrs |
| B napus (Athena) | 10 | 10 | 10 | 10 | 9.5 | 7.5 |
| B. napus (Dwarf Essex) | 10 | 10 | 10 | 9.5 | 7.0 | 3.0 |

¹Bioassay chamber consisted of a 50-dram snap-cap plastic vial, with 10 adults place in 9-dram snap cap vial with organdy top and drop of apple sauce for sustenance. Treatment material was placed at the bottom of the 2-dram glass vial.
²Treatments: 1) 0.75 g Brassica napus (Athena) + 4 ml water; 2) 0.75 g Brassica napus (S37) meal + 4 ml water.

TABLE 5
Fungus gnat larval volatile experiment¹ (n- = 2)

| | Mean number larvae alive: | | |
|---|---|---|---|
| Treatment² | after 90 minutes | after 20 hrs | after 43 hrs |
| Peat moss (control) | 10 | 10 | 10 |
| B. juncea (Pacific Gold) | 10 | 0 | 0 |
| S. alba (IdaGold) | 10 | 10 | 10 |

¹Bioassay chamber consisted of a 50-dram snap-cap plastic vial, with 10 last-instar larvae placed on small piece of agar sprinkled with small amount of sifted alfalfa meal in open 4-dram glass vial. Treatment material placed in a separate open 4-dram glass vial.
²Treatments: 1) 0.75 g peat moss + 4 ml water; 2) 0.75 g Brassica juncea meal + 4 ml water; and 3) 0.75 g Sinapis alba meal + 4 ml water.

TABLE 6
Fungus gnat larval volatile experiment¹ (n- = 2)

| | Mean number larvae alive after: | | |
|---|---|---|---|
| Treatment² | 90 min. | 17 hrs | 24 hrs |
| B. napus (Athena) | 10 | 9.5 | 9.5 |
| B. napus (Dwarf Essex) | 10 | 9.5 | 9.5 |

¹Bioassay chamber consisted of a 50-dram snap-cap plastic vial, with 10 last-instar larvae placed on small piece of agar sprinkled with small amount of sifted alfalfa meal in open 4-dram glass vial. Treatment material placed in a separate open 4-dram glass vial.
²Treatments: 1) 0.75 g Brassica napus (Athena) + 4 ml water; 2) 0.75 g Brassica napus (S37) meal + 4 ml water.

TABLE 7
Incorporation of meal into soil experiment (n = 3)

| | Mean number fungus gnat | nematodes |
|---|---|---|
| Treatment | adults emerged per pot | present (day 13) |
| B. napus 3% (control) | 15.7 | yes |
| B. juncea 1% | 11.3 | yes |
| B. juncea 3% | 0.0 | no |
| B. juncea 6% | 0.0 | no |

Treatments consisted of approximately 18 grams dry weight of a Sunshine mix no. 2/composted bark mixture (7:3); mixed with 1, 2, or 3% meal (Brassica napus ‘Athena’ or Brassica juncea ‘Pacific Gold’); plus approximately 1.6 grams dry pinto beans (soaked for 24 hrs in water) for larval food; plus the appropriated amount of water to have a moist mixture. This mixture was placed in plant pots (6 cm×6 cm×8 cm ht). Twenty fungus gnat larvae were added to the mixture in each of the pots. Numbers of adults emerging were recorded daily.

TABLE 8
Incorporation of meal into soil experiment (n = 3)

| | Mean number fungus gnat | nematodes |
|---|---|---|
| Treatment | adults emerged per pot | present (day 14) |
| B. napus 3% (control) | 15.0 | yes |
| S. alba 1% | 15.0 | yes |
| S. alba 3% | 14.7 | yes |
| S. alba 6% | 12.7 | yes |

Treatments consisted of approximately 18 grams dry weight of a Sunshine mix no. 2/composted bark mixture (7:3); mixed with 1, 2, or 3% meal (Brassica napus ‘Athena’ or Sinapis alba ‘IdaGold’); plus approximately 1.6 grams dry pinto beans (soaked for 24 hrs in water) for larval food; plus the appropriated amount of water to have a moist mixture. This mixture was placed in plant pots (6 cm×6 cm×8 cm ht). Twenty fungus gnat larvae were added to the mixture in each of the pots. Numbers of adults emerging were recorded daily.

TABLE 9
Gnat Larval Volatile Experiment¹ (n = 10).

| | Mean number larvae per container | | | | | |
|---|---|---|---|---|---|---|
| | alive (% alive) after: | | | | | |
| Treatment | 2 hrs | | 4 hrs | | 24 hrs² | |
| Brassica napus | 20.0 | (100%) | 20.0 | (100%) | 19.9 | (99.5%) |
| (Athena) | | | | | | |
| Brassica napus | 20.0 | (100%) | 20.0 | (100%) | 19.6 | (98%) |
| (Dwarf Essex) | | | | | | |
| Brassica juncea | 16.6 | (83%) | 0.0 | (0%) | 0.0 | (0%) |
| (Pacific Gold) | | | | | | |
| Sinapis alba | 20.0 | (100%) | 20.0 | (100%) | 19.4 | (97%) |
| (IdaGold) (batch 1) | | | | | | |

¹Bioassay chamber consisted of a 50-dram snap-cap plastic vial, with 20 last-instar larvae placed on small piece of agar sprinkled with small amount of sifted alfalfa meal in open 4-dram glass vial. Treatment material (1.0 g meal) placed in a separate open 4-dram glass vial. Five milliliters of water added to meal at start of experiment. Experiment set up on Feb. 21, 2002.
²Dead larvae in B. napus and S. alba treatments appear to have drowned, except possibly one larva in Dwarf Essex treatment.

TABLE 10
Incorporation of meal into soil experiment (n = 5).

| | Mean number | | | |
|---|---|---|---|---|
| | fungus gnat | | % survival | nematodes |
| | adults emerged | | (larvae to | present |
| Treatment | per pot | | adult) | (day 14) |
| B. napus (Athena) 20% | 13.6 ± 0.9 | a | 68 | yes |
| B. napus (D. Essex) 20% | 10.8 ± 2.0 | ab | 54 | yes |
| B. napus (D. Essex) 10% | 8.2 ± 1.2 | bc | 41 | yes |
| B. napus (D. Essex) 30% | 7.4 ± 0.9 | cd | 37 | yes |
| S. alba 10% (batch 2) | 5.0 ± 1.4 | d | 25 | yes |
| S. alba 20% (batch 2) | 2.0 ± 0.4 | e | 10 | yes |
| S. alba 30% (batch 2) | 1.8 ± 0.0 | e | 9 | yes |
| B. juncea 20% | 0.0 ± 0.0 | e | 0 | no |
| B. juncea 10% | 0.0 ± 0.0 | e | 0 | no |
| B. juncea 30% | 0.0 ± 0.0 | e | 0 | no |

Treatments consisted of approximately 18 grams dry weight of a Sunshine mix no. 2/composted bark mixture (7:3); mixed with 10, 20, or 30% meal; plus approximately 1.6 grams dry pinto beans (soaked for 24 hrs in water) for larval food; plus the appropriated amount of water to have a moist mixture. This mixture was placed in plant pots (6 cm×6 cm×8 cm ht). Twenty fungus gnat larvae were added to the mixture in each of the pots. Pots were placed in 1-quart canning jars with organdy top. Numbers of adults emerging were recorded daily. Soil mix was oven-dried overnight before use. Experiment set up on Feb. 28, 2002.

Means in a column followed by the same letter are not significantly different (P=0.05) using protected LSD.

TABLE 11
Incorporation of meal into soil experiment (n = 10).

| | Mean number fungus gnat | | percent survival |
|---|---|---|---|
| Treatment | adults emerged per pot | | (larvae to adult) |
| S. alba 1% (batch 2) | 15.6 ± 0.7 | a | 78.0 |
| S. alba 3% (batch 2) | 15.3 ± 0.6 | ab | 78.0 |
| B. juncea 1% | 14.8 ± 1.1 | ab | 73.5 |
| B. napus (D. Essex) 3% | 14.3 ± 0.9 | ab | 71.5 |
| B. napus 6% (Athena) | 14.0 ± 1.1 | ab | 70.0 |
| S. alba 6% (batch 2) | 12.7 ± 0.9 | b | 63.5 |
| B. napus (D. Essex) 1% | 12.5 ± 1.6 | b | 62.5 |
| B. napus (D. Essex) 6% | 7.9 ± 1.5 | c | 39.5 |
| B. juncea 3% | 0.7 ± 0.6 | d | 3.5 |
| B. juncea 6% | 0.0 ± 0.0 | d | 0.0 |

Treatments consisted of approximately 18 grams dry weight of a Sunshine mix no. 2/composted bark mixture (7:3); mixed with 10, 20, or 30% meal; plus 4 halves of pinto beans (soaked for 24 hrs in water) for larval food; plus the appropriated amount of water to have a moist mixture. This mixture was placed in plant pots (6 cm×6 cm×8 cm ht). Twenty fungus gnat larvae were added to the mixture in each of the pots. Pots were placed in 1-quart canning jars with sealed tops for 24 hrs, at which time organdy cloth replaced the lid. Numbers of adults emerging were recorded daily. Soil mix was oven-dried overnight before use. First five reps were set up on March 5 and second five reps were set up on Mar. 13, 2002.

Means in a column followed by the same letter are not significantly different (P=0.05) using protected LSD.

TABLE 12
Meal top-dressing and meal-incorporation into
soil surface experiment (n = 4).

| | Mean number | | Mean % | |
|---|---|---|---|---|
| | fungus gnat | | survival | |
| | adults emerged | | (larvae | Mean dry |
| Treatment | per pot | | to adult) | wt. Root |
| No meal, no | 13.3 ± 0.9 | a | 66.3 | * |
| disturbance | | | | |
| No meal, | 13.0 ± 1.6 | a | 65.0 | |
| disturbance | | | | |
| B. juncea | 9.3 ± 1.4 | ab | 46.3 | |
| 1%, top-dressing | | | | |
| B. juncea | 7.8 ± 2.4 | bc | 38.8 | |
| 1%, incorporated | | | | |
| 6-7 mm | | | | |
| B. juncea | 3.8 ± 1.9 | cd | 18.8 | |
| 3%, top-dressing | | | | |
| B. juncea | 5.8 ± 1.8 | bcd | 28.8 | |
| 3%, incorporated | | | | |
| 6-7 mm | | | | |
| B. juncea | 2.3 ± 1.3 | d | 11.3 | |
| 6%, top-dressing | | | | |
| B. juncea | 2.8 ± 1.3 | d | 13.8 | |
| 6%, incorporated | | | | |
| 6-7 mm | | | | |

Pinto bean seeds were planted into soil mixture (19 or 20 grams dry weight) in plant pots (6 cm×6 cm×8 cm ht) on March 9 (block 1) and Mar. 21, 2002 (block 2). Soil mixture consisted of Sunshine mix no. 2/composted bark mixture (7:3). Twenty fungus gnat larvae were added March 25 (block 1) and April 2 (block 2) to the soil mixture (˜1-2 cm deep) in each of the pots. Pots were placed in 1-quart canning jars with organdy top. Numbers of adults emerging were recorded daily. Soil mix was oven-dried overnight before use. Twenty-five ml water was added to soil surface of each pot (block 1) on March 28, March 31, April 3, and April 7. Twenty ml water was added to soil surface of each pot (block 2) on April 5, April 8, April 11, and April 14.

Means in a column followed by the same letter are not significantly different (P=0.05) using protected LSD.

*=root not weighed

### Example 7

It was expected that Sinapis alba meal would produce an isothiocyanate that would inhibit mycelial growth of this fungal pathogen. However, no such effect was observed, thus prompting a determination of the fate of 4-OH benzyl isothiocyanate.

Mycelial growth of Fusarium oxysporum in the presence of different meals F. oxysporum strains #9051C, #9243G, #9321A and #9312 F were obtained from forest nurseries in which this fungal pathogen is a problem. Toxicity of meal volatiles against mycelial growth was determined in closed containers. Growth was determined by measuring colony diameters.

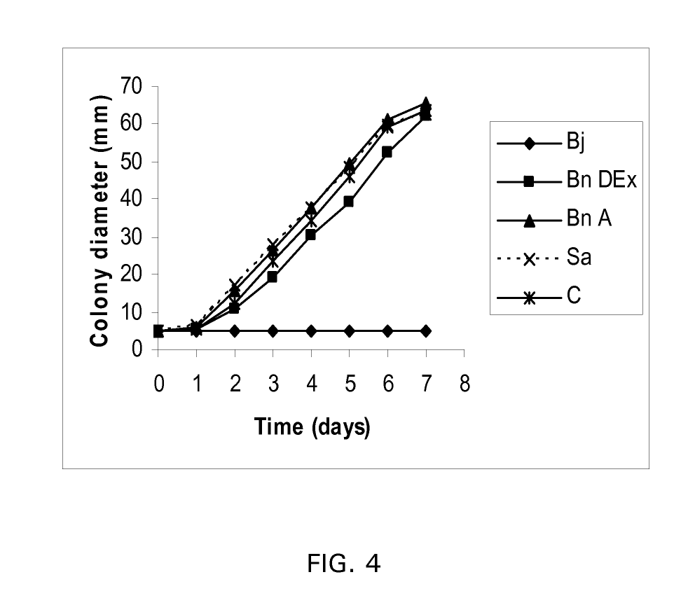

FIG. 4 shows that B. juncea Pacific Gold meal completed suppressed mycelial growth of F. oxysporum in these bioassays. B. napus Dwarf Essex had a slight effect on growth. No effect of S. alba on mycelial growth was observed in current bioassays. It is possible that volatile products from S. alba are minimal and that fungal inhibition may occur if non-volatile glucosinolate hydrolysis products bioassayed. However, this seems unlikely given the fact that little effect on fungus gnats and nematodes was observed when using S. alba meal. All isolates behaved similarly.

### Example 8

### Glasshouse Seed Meal Toxicity on Plant Growth

Plant health can be affected by a variety of soil-borne pests and diseases, including: bacteria, fungi, nematodes, insects, and weeds. Much is now know about the effect of glucosinolate breakdown products on a wide range of soil-borne pests and diseases. However, there has been little effort made to determine the effect of these compounds on crop plants planted after soil treatment. This study was designed to determine the effect of time after planting on crop plant growth.

Sunshine mix potting soil was incorporated with 1-ton, 2-ton, and 4-ton equivalent of Brassica napus, Brassica juncea, and Sinapis alba, seed meals and potting mix with no amendment as control. After incorporation, the seedling flats were filled and randomly arranged on a bench. Seeds of canola (B. napus), oriental mustard (B. juncea), yellow mustard (S. alba), lettuce (Lactuca sative), sugar beet (Beta vulgaris) and corn (Zea mays) were planted into amended soil treatments 1 day, 2 day, and 4 days after incorporation. Plant counts were recorded daily and after 22 days above ground biomass was determined on each sample. The experimental design was a 3 replicate split plot design with days after treatment as main plots and soil amendment as sub-plots.

Seedling emergence and plant growth of canola, oriental mustard and yellow mustard were all greatly affected when planted into amended soils compared to the control. Soil amended with S. alba meal showed lowest plant survival levels whereby less that 30% of seedlings either failed to emerge or survive compared to the control where 100% survival was found. B. napus-amended soils resulted in over 80% plant survival, while B. juncea was intermediate with just over 51% plant survival. A similar result occurred in corn and sugar beet, where S. alba amended soil showed significantly lower plant survival compared to B. juncea- or B. napus-amended soils. Lettuce emergence was very poor even in the control treatment and plant survival levels were not significantly different over any treatment, albeit that they were all very low. Increasing meal amendment rate significantly reduced plant survival in all species examined. However, lowest survival occurred with S. alba meal treatments.

Plant dry weight 22 days after planting showed a similar trend to plant counts. Averaged over amendment rates, plants grown in B. juncea-amended soil had above ground biomass which was only 35% that of the control. Plants grown in B. napus-amended soils were only one quarter the biomass of the control plants while plants grown in S. alba-amended soil were less than 5% dry matter of the control. All seed meals therefore interfered with plant growth even when planting was delayed for 4 days after the initial soil treatment. Plant stunting was not significantly different when seeds were planted immediately after soil amendment or when planting was delayed for 4 days after treatment. Corn and sugar beet plants were stunted in B. juncea- and S. alba-amended soils in a similar manner. Canola, both mustards, sugar beet and corn plant dry weights were reduced with increased concentrations of either B. juncea or S. alba meal. It was noted, however, that the lowest concentration of S. alba meals resulted in plant dry weights equal to the highest concentration of the other seed meals. Plants grown in B. napus-amended soils were significantly higher dry matter than the control. B. napus seed meal had significantly lower concentration of glucosinolates compared to the two mustard meals studied. It is possible that the concentration or type of glucosinolate in B. napus does inhibit germination but not growth after emergence. As all seed meals are high in nitrogen this might explain the larger plants grown in B. napus-amended soils.

Overall, all three meals have potential to significantly reduce seedling emergence and plant survival in amended soils. S. alba was most effective in killing either seeds or seedlings and had the most detrimental effect on plant growth. Soils amended with S. alba meal could offer an alternative biological herbicide. However, more needs to be done to examine the phytotoxicity effect of Brassicaceae seed meal soil amendments and their effect on the crop that is to be planted after treatment.

### Herbicidal Efficacy of Brassica Seed Meal in Glasshouse Studies.

Sterilized potting compost was infected with uniform numbers of wild oat and pigweed seeds. After the seeds and compost were mixed they were amended with S. alba IdaGold (yellow mustard), B. juncea Pacific Gold (Oriental mustard) or B. napus Athena (canola) seed meals at a rate of 1.0 ton or 0.5 ton an acre equivalent and weeds seeds allowed to germinate and grow for four weeks. Each treatment combination, along with a no treatment control was grown in a four replicate randomized block design with each plot being a seedling flat 36×20 cm.

After four weeks the number and dry weight of wild oat plants and pigweed plants was recorded. Amending soil with 1 ton of B. juncea Pacific Gold meal reduced wild oat populations from 96 in the control to 16. Neither rate of IdaGold amendment showed the same degree of wild oat elimination. In sharp contrast, when the broadleaf weed (pigweed) was considered, the reverse was true whereby the Pacific Gold was less effective than the control in controlling weed numbers and a significantly higher weed biomass was produced in the Pacific Gold soil treatments. In the case of pigweed, IdaGold was most effective, reducing population numbers by almost 90% compared to the Pacific Gold treatment. These studies are currently being repeated to confirm the striking results that one mustard type is controlling grassy weeds while the other is specific to broadleaf weeds.

### Initial Field Studies

Initial field studies were conducted to investigate: (1) the effect of different Brassica species seed meals on establishment and growth of potato, corn, strawberry, recrop cherry, cabbage, rutabaga, lettuce, field beans, and spring wheat; and (2) to evaluate herbicidal potential of using different Brassica seed meals

### Potato and Sweet Corn

One super sweet corn cultivar and three potato cultivars (‘Yukon Gold’, ‘White Rose’, and ‘IdaRed’) were planted into ridged seed beds. Prior to ridging, the complete plot area was divided into strips 20 feet wide. Each strip was assigned to a specific seed meal treatment. Seed meal treatments were: (1) Brassica napus seed meal at 1 ton/acre; (2) B. napus seed meal at 2 ton/acre; (3) B. juncea seed meal at 1 ton/acre; (4) B. juncea seed meal at 2 ton/acre; (5) Sinapis alba seed meal at 1 ton/acre; (6) Sinapis alba seed meal at 2 ton/acre; (7) a chemical treatment control; and (8) a no chemical control. The seed meal was applied by hand application. The ridges were drawn and the whole plot area irrigated with approximately 2 inches of irrigation water. The corn and potato cultivars were planted at right angles to the seed meal treatments 21 days after treatment. The experimental design therefore was a strip plot design and was replicated twice.

### Strawberry and Cherry

Two strawberry cultivars (‘June Bearing’ and ‘Ever Bearing’) and one self-pollinating ‘Bing’ cherry cultivar were chosen for this study. The strawberry research area was divided into eight 20 foot wide strips×36 feet long. Each strip was associated with a different seed meal treatment (B. napus, B. juncea, S. alba and a non-treatment control). Seed meal was applied by hand at a rate of 1 ton/acre, the seed meal worked in by tillage and ridges were drawn. Strawberry plants which had previously been hardened were planted by hand into the ridges 22 days after treatment. The experimental design was a strip plot design with cultivars arranged at random within blocks, and four replicates. Each plot was 20 feet×2 rows.

An area of ground was divided into 20×20 feet units. Each unit was treated with either 1 ton/acre of each B. juncea or S. alba seed meal, 2 ton/acre of each seed meal, and a non-treatment control (i.e. 2 seed meals types×2 application rates, plus a control). This was replicated twice.

On-farm testing of Pacific Gold and IdaGold seed meal as a pesticide/nematicide in recrop orchards was initiated at The Dalles in Oregon. The complete trial covered 9 acres which was divided into 18×0.5 acre plots. In the fall of 2002 a randomized complete block design was superimposed on the trial area with 5 treatments: (1) the standard chemical nematicide, Telone®; (2) Pacific Gold meal at 1 ton/acre rate applied in the fall; (3) Pacific Gold meal at 1 ton/acre rate applied in the spring (4) Pacific Gold meal at 0.5 ton/acre rate applied in the fall and the spring (5) IdaGold meal at 1 ton/acre rate applied in the fall; (6) IdaGold meal at 1 ton/acre rate applied in the spring (7) IdaGold meal at 0.5 ton/acre rate applied in the fall and the spring (9) winter wheat cover crop; and (9) a no treatment control, with each treatment replicated twice.

As of the date of this report, the fall and spring seed meal rates have been applied. Three weeks after the fall treatment, samples of soil were taken from each plot for nematode analyses. A further soil sample was taken after spring treatments and Telone application. The new cherry trees will be transplanted in Mid-May.

### Vegetables and Wheat

Five crops were chosen for this study (rutabaga, cabbage, bean, lettuce and wheat). Wheat was included as we wanted to include a monocot and also as wheat is highly adapted to this region. The trial area was divided into 5 treatment strips 20 feet wide. Treatments were: B. napus, B. juncea and S. alba seed meals at 1 ton/acre rate, plus a chemical control treatment and a non-treatment control. Each treatment was replicated twice. Seed meal was applied by hand and roto-tilled to a depth of 4 inches prior to being irrigated (1 inch). Crops were planted using a double disc seed drill 21 days after treatment.

### Variates Recorded

On each trial, general plant health was visibly assessed on a daily basis for 21 days after emergence. Plant emergence rates were recorded on all trials. Crop yield was recorded on all crops as they became marketable. Ant disease on plants or harvested product was recorded.

Weed plant counts were recorded on a 1-m² plot area on all plots at weekly intervals. Weed biomass was taken 10 weeks after planting. Weed plats from 1 m² were clipped at ground level, bagged, and oven dried before weights were recorded.

Crop emergence of potato and corn were not affected by any of the seed application treatments. Indeed, the smallest and later emerging crops were always in the non-treatment control. Overall there was no significant difference in crop emergence or establishment over all treatments.

All seed meal treatments resulted in a significant reduction in the number of weed plants compared to the non-treatment control in both potato and corn. Amongst the seed meal treatments, S. alba meal was most effective in weed control and indeed was not significantly higher than the chemical control in either potato (Sencor) or corn (Harmony Extra). Least effect weed control was in the B. juncea treatments where over 3 times the weed plants were found compared to S. alba.

None of the strawberry plants transplanted in failed to establish in any treatment. It was evident in the few days after transplanting that there was visibly more browning around the leaf margin. This browning was most striking in the Ever Bearing cultivar which has large thin leaves compared to June Bearing. The symptoms were markedly stronger in the S. alba treatments compared to the other seed meals used.

Weed control in the strawberry trial was striking. On average the non-treatment control had 35 weed plants/m². The chemical control (actually hand weeding) had almost none. The B. napus treatments had on average 12 weeds/m², The B. juncea slightly better with 8 weed plants/m². However, there were almost no weeds in the S. alba, which was equivalent to the chemical control.

Weed control in the cherry orchard was equally as striking as the strawberry with mass weed populations (mainly pigweed and lambsquarter) in all treatments except the IdaGold treatments. Initial nematode counts after the fall treatments of The Dalles on-farm test were are follows: no treatment control=1,203 nematodes; winter wheat cover crop=1,197 nematodes; IdaGold soil amendment=701 nematodes; Pacific Gold soil amendment=232 nematodes. The Telone treatment is spring only.

Crop emergence was more erratic in the vegetables than in the other crops. Overall, however, there was no significant difference between soil treatments and crop emergence, and indeed if a trend did exist it was that the ‘better’ crop emergence was in the S. alba treatments compared to the other seed meal treatments.

Weed control in the vegetable trial was as striking as that in the strawberry plots. The results were very similar to those above. Weeds were devastating in all crops without any treatment, averaging more than 25 weeds/m². Both B. napus and B. juncea treatments resulted in a significant reduction in weed populations; they were both significantly higher than the complete control. S. alba meal treatment resulted in the elimination of almost all weeds in all crops and was not significantly different from the complete control treatment.

Corn yield in the Pacific Gold and Athena treatment was not significantly different from the chemical control, but the IdaGold corn was significantly lower yielding as was the no treatment control. Highest potato yield was obtained after Pacific Gold and Athena application, followed by IdaGold, the chemical control and lowest potato yield was with the no treatment control. Highest yield of strawberry was with the chemical control. All three seed meal treatments produced higher strawberry yield than the control. IdaGold treatment produced significantly higher cabbage yield than other treatments as did the chemical control with lettuce production. Lettuce appeared to be least sensitive to IdaGold meal treatments.

The overall conclusion from this study is that Brassica seed meals have little or no effect on the crop of crops planted or transplanted 21 days after treatment. Both B. napus and B. juncea seed meal treatments significantly reduced weed populations over a no treatment control. S. alba seed meal treatments almost eliminated all weed growth and the weeds that did emerge could easily have been explained by less than fully effective seed meal incorporation.

Overall, seed meal treatments were as productive as the chemical control for most crops. IdaGold treatment appeared to have residual negative effect on corn and lettuce growth.

### Example 9

Two studies were conducted to examine the effects of amending soil with defatted Brassicaceae meal on the establishment of weed seedlings. Based on the observations of greenhouse and field experiments, the meal from Sinapis alba “Idagold” appears to have the greatest potential for effective weed control. In an effort to better understand the dose response of weed seed germination and establishment, the following studies were performed:

1. Incorporation of Idagold meal at 8 rates with 3 weed species

2. Top-dressing of Idagold meal at 8 rates with 2 weed species

Meal was obtained from the University of Idaho's onsite crushing facility. The seed used to produce the meal was #1 grade seed purchased through the Genesee Union. Meal rates were determined as a percentage of the dry soil weight and ranged from 0 to 0.97%. The highest rate is equivalent to an application of 4 tons per acre incorporated into the top three inches of soil.

Redroot pigweed, wild oat, and common lambsquarter seed was received from an associate of Dr. Donn Thill. A germination test was performed following the 1^{st} experiment, which showed a lack of germination viability in the stock of common lambsquarter seed. Weed seeds were either hand-counted (wild oat) or carefully weighed (pigweed and lambsquarter) into proper allotments and then planted into rows randomly positioned within the trays.

The soil used was obtained from a local organically-managed farm (Mary Jane Butter's Paradise Farm) and was passed through a 2 mm screen. While this soil has not been chemically or texturally analyzed, it appears to be a fine silt-loam rich with organic matter (an analyses is planned for this soil). Weighed allotments of soil were amended with meal either by mixing them together in a container prior to pouring the soil into a seedling tray (incorporation) or by sprinkling the meal onto the soil after it had been poured and leveled in the tray (top-dressing).

Each tray thus consisted of two rows of each weed species and was amended with meal at a rate of 0, 0.06, 0.12, 0.18, 0.24, 0.30, 0.49, 0.73, or 0.97% of dry soil weight. Each treatment was replicated five times, and the experiment was conducted following a randomized complete block design.

The moment the trays were watered initiated time zero, the trays were subsequently watered daily for two weeks; afterwards they were watered twice a week. Although daily emergence data was collected, the final total of emerged and established seedlings is of much greater interest. It should be noted that a delay in the emergence of weeds may provide the desired level of weed control in some situations. However, in this study the focus was on the dose response of the weeds to the amount of meal amendment. Both species (pigweed and wild oat) responded negatively to increasing levels of meal amendment (FIG. 5).

TABLE 13

| | Number of established seedlings vs. dose of meal | | | |
|---|---|---|---|---|
| Dose | pigweed-inc | pigweed-top | wild oat-inc | wild oat-top |
| 0 | 84.2 | 27 | 25.2 | 26.2 |
| 0.06 | 68.4 | 24.2 | 30 | 24.2 |
| 0.12 | 26.2 | 11 | 19.8 | 26.6 |
| 0.18 | 10.8 | 10.4 | 22.4 | 22 |
| 0.24 | 9 | 10.2 | 19.8 | 21.2 |
| 0.3 | 7.6 | 2 | 12.8 | 17.8 |
| 0.49 | 1.2 | 1.4 | 9 | 11.8 |
| 0.73 | 1.2 | 1.2 | 2.8 | 11.8 |
| 0.97 | 2 | 0.6 | 3.8 | 6.6 |

S. alba or “Idagold” meal is useful as a soil amendment for weed control. The methodology might be modified by changing the depth of planting, scarifying the seed prior to use, etc. Since there appears to be no appreciable difference between incorporation and top-dressing, future top-dressing only may be the most practical method of applying.

### Example 10

This example discusses using the method for pest control comprising disclosed embodiments of the present invention by extracting intact glucosinolates, such as 4-hydroxybenzyl glucosinolate, and applying the extract to soil either as a top dressing or by incorporating the extract a certain depth into the soil, such as from 0.25 to about 5.0 centimeters. Plant tissue is extracted with an extractant, such as an aqueous alcohol, e.g. methanol, solution. The plant tissue optionally may be pressed, such as by cold pressing, prior to extraction. Selected glucosinolates are obtained as extracts by this procedure.

In a first embodiment, extracted glucosinolate is applied to selected soil at a desired application rate selected for pest control. Thereafter, an effective amount of myrosinase enzyme also is added to the soil to produce active biopesticides.

Alternatively, the extracted glucosinolate can be combined with the myrosinase to form a mixture, and then the mixture is applied to selected soil at a desired application rate selected for pest control.

Another possibility for effective utilization of S. alba meal as an herbicide is to add water to the meal, causing enzymatic hydrolysis of 4-OH benzyl glucosinolate by the contained myrosinase. The resulting aqueous solution that now contains SCN⁻ could then be applied as a spray to soil or to the weed itself. To facilitate such a process a volume of S. alba meal could be enclosed or encapsulated in a container that would allow water penetration. The capsule or container could be dropped in a known volume of water, thus promoting hydrolysis of the contained 4-OH benzyl glucosinolate and providing a recommended SCN⁻ rate adequate for weed control. The resulting SCN⁻ solution could then be sprayed on soil or directly on weeds without the need to apply meal.

### Example 11

Seed meal from S. alba (yellow mustard) was evaluated for effects on seed germination and establishment compared to a no treatment control. Seedling flats (26 by 52 by 7.5 cm) were filled with potting media and then 4 grams each of wild oat or 1 gram of redroot pigweed seeds were sprinkled on the media surface and thoroughly mixed into the potting media. The meal treatments were 0.5 and 1.0 metric t/ha, equivalents weight by area, of IdaGold yellow mustard meal. Seed meal was thoroughly mixed into the soil in flats after seeding the weed seeds. The experimental design was a randomized complete block with four replicates, and the experiment was conducted three times. Immediately after incorporation of the meal, all flats were watered equally with 3 centimeters of water to encourage glucosinolate hydrolysis. Seedlings emergence counts and above ground plant biomass after three-weeks growth were determined.

Only the higher application of S. alba seed meal resulted in a significant reduction in redroot pigweed (Table 14). However, both the S. alba application rates produced significantly lower redroot pigweed biomass compared to the no-treatment control. Similarly, the S. alba meal amended soils resulted in significantly lower wild oat seedlings and significantly lower weed biomass compared to the no-treatment control. In conclusion, S. alba seed meal showed significant herbicidal effects compared to a no-treatment control.

TABLE 14
Weed count and biomass from meal amended
soils and a no-treatment control.

| | | Redroot Pigweed | | | Wild Oat | |
|---|---|---|---|---|---|---|
| | | | | Weed | | Weed |
| | Rate | Weed count | | Biomass | Weed count | Biomass |
| Treatment | Mt ha⁻¹ | Plant m² | | g m² | Plant m² | g m² |
| No meal | 0 | 150 | a | 0.729 a | 99 a | 9.6 a |
| S. alba | 0.5 | 99 | ab | 0.159 b | 67 b | 6.6 b |
| meal | 1.0 | 45 | b | 0.139 b | 41 c | 4.3 c |

Means within columns with different letters are significantly different (P < 0.05)

### Example 12

Two ton/acre equivalent seed meal rates of Sinapis alba L. (IdaGold) were used as soil amendment treatments along with a no-treatment control. The S. alba meal was incorporated by hilling or tilling the top two inches of soil. Two weeks after seed meal was incorporated crops were planted, including lettuce (Lactuca sativa), field beans (Phaseolus spp.), cabbage (B. oleracea), strawberries (Fragaria x ananassa Duchesne), corn (Zea mays), and potatoes (Solanum tuberosum). Experiments were planted in a split plot design with soil treatments assigned as main plots and crops assigned to sub-plots. All crops were hand harvested.

Weed density was significantly different between S. alba soil amendment treatments compared to the no-treatment control in all crops examined (Table 15). In conclusion S. alba (IdaGold) was most effective in reducing weed populations and in most cases weed control was excellent.

TABLE 15
Weed population in different crops planted into soil amended
with S. alba seed meal and from a no-treatment control.

| | |
|---|---|
| S. alba meal | No-treatment |
| amended soils | control |

| | |
|---|---|
| Crop | Weed plants m² |

| | | |
|---|---|---|
| Corn | 14.0 a | 2.2 b |
| Potato | 13.5 a | 2.0 b |
| Strawberry | 34.5 a | 1.0 b |
| Cabbage | 21.2 a | 0.1 b |
| Lettuce | 28.0 a | 0.2 b |
| Field Bean | 32.3 a | 0.2 b |
| Average | 23.9 a | 0.9 b |

Means within rows with different letters are significantly different (P < 0.05)

The present invention has been described with reference to certain exemplary embodiments. A person of ordinary skill in the art will appreciate that the present invention is not limited to these exemplary embodiments.

### Example 13

Studies were established in a greenhouse at the University of Idaho, Moscow, Id. in winter 2006 to evaluate the effect of water extractions of S. alba seed meal on the growth of common lambsquarters, ‘Yaya’ carrot, green ‘Summer Crisp’ lettuce, and spring wheat. Greenhouse flats were 20 by 28 by 5 cm, arranged in a randomized complete block design with six replications. S. alba mustard seed meal applications equivalent to 2.2, 4.5, 9, 13.5, and 18 metric tons per hectare were extracted with tap-water at room temperature (20° C.) at a 7.3:1 ratio of seed meal to tap-water. Extraction was performed by shaking seed meal in Erlenmeyer flasks for 30 minutes at 300 rpm. Supernatants were strained 3 times with a 28 mesh screen to remove precipitated material. Twenty seeds of common lambsquarters, ‘Yaya’ carrot, green ‘Summer Crisp’ lettuce, and spring wheat were planted in rows 14 days prior to treatment. Greenhouse temperatures were set at 23/12° C. day and night, respectively, with a photoperiod of 16/8 hours day and night, respectively. Above ground seedling biomass was harvested by species 16 days after treatment. Seedling biomass was dried at 15° C. for 72 hours and weighed.

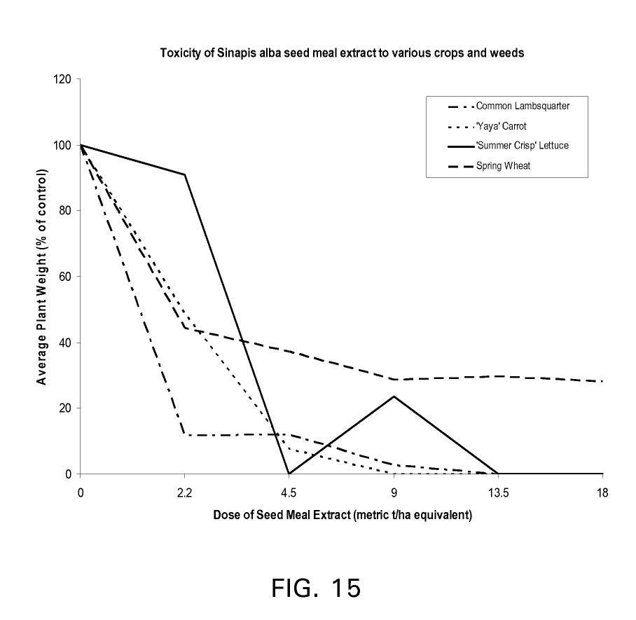

A general trend of decreasing plant biomass with increasing doses of S. alba seed meal supernatant extraction was observed (FIG. 15). The large reduction in plant biomass between a dose of 0 and a dose of 2.2 metric t/ha indicates that reduction in plant biomass at doses lower than 2.2 metric t/ha may be possible. While common lambsquarters, ‘Yaya’ Carrot, and ‘Summer Crisp’ lettuce were all reduced to a plant biomass of 0 with a dose of 13.5 metric t/ha, spring wheat showed some tolerance to the treatment, as indicated by an almost flat dose response between 9 and 18 metric t/ha.

The foregoing disclosed embodiments have been described in detail by way of illustration and example for purposes of clarity and understanding. As is readily apparent to one skilled in the art, the foregoing are only some of the embodiments illustrative of the foregoing invention. It will be apparent to those of ordinary skill in the art that variations, changes, modifications and alterations may be applied to the disclosed embodiments described herein. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope, and concept of the invention as defined by the appended claims.

We claim:

1. A method, comprising:
providing plant material, processed plant material, composition comprising plant material or composition comprising processed plant material selected from the family Brassicaceae; and
applying the plant material, processed plant material, composition comprising plant material or composition comprising processed plant material to soil prior to crop planting, simultaneously with crop planting, or subsequent to plant emergence.

2. The method according to claim 1 where providing processed plant material comprises liberating a substantial portion of oil from the plant material to produce a processed plant material.

3. The method according to claim 1 where the plant material is selected from a genera Brassica and Sinapis.

4. The method according to claim 3 wherein the plant material is Sinapis alba material.

5. The method according to claim 4 wherein the processed plant material is a seed meal from Sinapis alba.

6. The method according to claim 1 wherein the plant material has a concentration based upon dry weight of the plant material of 4-hydroxybenzyl glucosinolate ranging from about 10 μmol/gram to about 500 μmol/gram.

7. The method according to claim 1 wherein the plant material has a concentration of 4-hydroxybenzyl glucosinolate of from about 10 μmol/gram to about 400 μmol/gram.

8. The method according to claim 1 wherein the processed plant material has a concentration of 4-hydroxybenzyl glucosinolate of from about 50 μmol/gram to about 250 μmol/gram.

9. The method according to claim 1 wherein the processed plant material has a concentration of 4-hydroxybenzyl glucosinolate of from about 75 μmol/gram to about 210 μmol/gram.

10. The method according to claim 1 where the plant material, processed plant material, composition comprising plant material, or composition comprising processed plant material is applied to control insects, nematodes, fungi, weeds, or a combination thereof.

11. The method according to claim 1 where the plant material is crushed to produce a processed plant material.

12. The method according to claim 11 where the processed plant material is pelletized Sinapis alba seed meal.

13. The method according to claim 1 where the plant material is combined with at least one additional material to form a composition.

14. The method according to claim 13 where the at least one additional material is a natural biopesticidal fumigant, a natural fertilizer, a synthetic pesticide, a binder, a colorant, a pH adjuster/stabilizer, capsaicin, onion tissue, a microorganism, a product provided by a microorganism or a combination thereof.

15. The method according to claim 1 further comprising controlling the amount of water added to soil to which the plant material, processed plant material, composition comprising plant material or composition comprising processed plant material is applied.

16. The method according to claim 15 where the amount of water added is an amount selected to maintain bioactivity.

17. The method according to claim 16 where the amount of water is from about 1/16 inch of water up to about 0.75 inch of water.

18. The method according to claim 1 where applying comprises top dressing or amending the meal to the soil surface.

19. The method according to claim 1 where applying comprises incorporating into the top 2 inches of soil.

20. The method according to claim 1 further comprising controlling pH levels of the soil to which the plant material, processed plant material, composition comprising plant material, or composition comprising processed plant material is applied.

21. The method according to claim 1 comprising applying plant material, processed plant material, composition comprising plant material or composition comprising processed plant material simultaneously with crop planting, where crop is a food crop.

22. The method according to claim 21 where the food crop is carrots and the plant material is S. alba.

23. The method according to claim 1 where plant seeds are used.

24. The method according to claim 23 where the plant seeds are crushed to form seed meal.

25. The method according to claim 24 where the seed meal is pelletized.

26. The method according to claim 1 where the plant material is Sinapis alba, and the Sinapis alba is applied to control weeds selected from the group consisting of prickly lettuce (Lactuca serriola), mayweed chamomile (Anthemis cotula), common lambsquarters (Chenopodium album), wild oat (Avena fatua), redroot pigweed (Amaranthus retroflexus), or a combination thereof.

27. The method according to claim 1 where the composition comprising plant material or the composition comprising processed plant material is an aqueous extract composition, and where the method further comprises applying the aqueous extract composition to the soil prior to, simultaneously with or subsequently to the application of an enzyme.

28. A method, comprising:
providing plant material from a genus Brassica and Sinapis;
liberating a substantial portion of oil from the plant material to produce a processed plant material;
applying the processed plant material to a soil at some amount greater than zero to about 5 tons per acre; and
controlling water applied to maintain active agent bioactivity.

29. The method according to claim 28 further comprising controlling pH levels of soil to which the plant material or processed plant material is applied.

30. The method according to claim 28 wherein the plant material is Sinapis alba.

31. The method according to claim 30 wherein the Sinapis alba is crushed to produce seed meal, and the seed meal is used as a biopesticidal.

32. The method according to claim 31 wherein seed meal is pelletized seed meal.

33. The method according to claim 32 wherein the seed meal is further formulated with at least one additional material to form a composition.

34. The method according to claim 33 where the at least one additional material is selected from the group consisting of synthetic organic herbicides, synthetic organic pesticides, bioactive plant materials in addition to the Sinapis alba plant material, or a combination thereof.

35. The method according to claim 28 where the plant material is Sinapis alba applied to control weed growth for weeds selected from the group consisting of prickly lettuce (Lactuca serriola), mayweed chamomile (Anthemis cotula), common lambsquarters (Chenopodium album), wild oat (Avena fatua), redroot pigweed (Amaranthus retroflexus), or a combination thereof.

36. The method according to claim 28 where the plant material is Sinapis alba, and the method further comprises germinating plant crops in the presence of the Sinapis alba, where the plant crops are food crops.

37. The method according to claim 36 where the food crop is carrots, and the method comprises germinating seed in both pelleted and unpelleted form in the presence of Sinapis alba meal provided at concentrations sufficient to kill or significantly damage weeds.

38. The method according to claim 28 where the plant material or processed plant material is applied to control insects, nematodes, fungi, weeds, or a combination thereof.

39. A method, comprising:
forming an aqueous composition comprising a plant material or a processed plant material selected from the family Brassicaceae; and
applying the composition, or water from the composition, to soil.

40. The method according to claim 39 comprising adding water to meal, causing enzymatic hydrolysis of 4-OH benzyl glucosinolate by myrosinase.

41. The method according to claim 39 where applying comprises spraying the composition or water from the composition directly onto soil.

42. The method according to claim 39 where S. alba meal is combined with a known volume of water to promote hydrolysis of 4-OH benzyl glucosinolate.

43. The method according to claim 39 where the composition or water from the composition is applied to control insects, nematodes, fungi, weeds, or a combination thereof.
